(19) United States
(12) Patent Application Publication
(10) Pub. No.: US 2024/0228237 A1
(43) Pub. Date: Jul. 11, 2024

(54) SECUREMENT AND OR THRUSTER RELOCATION FOR SUSPENDED LOAD CONTROL APPARATUSES, SYSTEMS, AND METHODS

(71) Applicant: Vita Inclinata IP Holdings LLC, Broomfield, CO (US)

(72) Inventors: Derek Sikora, Denver, CO (US); Logan Goodrich, Golden, CO (US); Jonathan Zeller Oster, Denver, CO (US); Joseph Edward Gilford, Denver, CO (US)

(73) Assignee: Vita Inclinata IP Holdings LLC, Broomfield, CO (US)

(21) Appl. No.: 18/616,166

(22) Filed: Mar. 26, 2024

Related U.S. Application Data
(63) Continuation-in-part of application No. 17/752,509, filed on May 24, 2022.
Application No. 17/752,509 is a continuation of application No. 17/398,638, filed on Aug. 10, 2021.
Application No. 17/398,638 is a continuation of application No. PCT/US2020/017790, filed on Feb. 11, 2020.
Application No. 17/398,638 is a continuation-in-part of application No. 16/247,791, filed on Jan. 15, 2019, now Pat. No. 10,479,503.
(60) Provisional application No. 63/464,626, filed on May 7, 2023.
(60) Provisional application No. 62/804,020, filed on Feb. 11, 2019.
(60) Provisional application No. 62/757,414, filed on Nov. 8, 2018.
(60) Provisional application No. 62/627,920, filed on Feb. 8, 2018.

(51) Int. Cl. B66C 13/08; A61G 1/06; A61G 3/00; B64D 1/22; B66C 13/06

(52) U.S. Cl. CPC B66C 13/085; A61G 1/06; A61G 3/006; B64D 1/22; B66C 13/063; A61G 2220/10

(57) ABSTRACT

Disclosed are a thruster positioning mechanism and a securement mechanism for use in relation to a suspended load control apparatus or system to control a load suspended by a cable from a carrier.

### FIELD

This disclosure is directed to an improved modular suspended load control apparatus, systems, and methods for use thereof.

### BACKGROUND

People and/or equipment (“loads”) may be transported to or from a location as a load suspended by a cable from a carrier such as a helicopter, crane, or fixed wing aircraft using a hoist system. The loads are typically not buoyant, though may be. Cranes, helicopters, fixed wing aircraft, buildings, and the like may be referred to herein as “carriers”. During such suspended load operations, loads are subject to winds and other external and internal factors that may cause the load to move in an unstable, unpredictable, undesirable, and/or hazardous manner.

Operators of carriers, such as helicopter and crane crews, may use equipment that provides control of a suspended load, including equipment that provides suspended load control remote from the carrier, e.g. at or near a load, using remotely powered fans. Such equipment is referred to herein as a suspended load control system (“SLCS”).

In hoist and sling operations or otherwise when transporting or carrying a suspended load by a carrier, observed motion of suspended loads includes the following components: vertical translation (motion up and down) along the Y axis (referred to herein as “vertical translation”); horizontal translation along either or both the X and Z axis; and rotation or “yaw” about the Y axis. Roll (rotation about the X axis) and pitch (rotation about the Z axis) may also occur, though if a load is suspended by a cable and is not buoyant, the typical motions are vertical translation, horizontal translation, and yaw. Vertical and horizontal translation may be caused by movement of the suspension cable, movement of the carrier, winding of a winch up or down relative to a carrier, movement of the load, differences in speed and momentum between the load and the carrier, by wind—including propeller wash—impacts, and external forces. Horizontal translation can manifest as lateral motion or as conical pendulum motion of the load, with the pivot point of the pendulum where the cable is secured to the carrier (“pendular motion”); pendular motion generally also includes a component of vertical translation and may also be referred to as elliptical motion.

Yaw, lateral motion, and pendular motion complicate lift operations, cause delays, injury, and can lead to death of aircrew, crane operators, operators of other carries, damage to buildings and equipment, and injury and risk exposure to people in the carrier and on the ground. Yaw can produce dizziness and disorientation in humans and transported non-human animals. Yaw and lateral and pendular motion can also interfere with bringing a load into or delivering a load to a location. For example, delivery of a load to a deck of a ship may be complicated by pendular motion or yaw of the load, even if the deck is stable and is not also subject to heave, roll, or pitch, as it may be. For example, bringing a person in a litter into a helicopter or onto a helicopter strut may be hazardous if the litter is undergoing yaw or pendular motion as it is drawn up to the helicopter. One or more components of undesired motion of the load may increase in amplitude and/or frequency and otherwise grow more pronounced as a load is drawn up to the carrier and the suspension cable shortens. Horizontal and pendular motion of a load can also interact with the carrier to produce dangerous reactive or sympathetic motion in the carrier.

In addition, some suspended load operations may involve an obstacle, such as a surface, cliff wall, building, bridge, tree limb, overhang, or other obstacle that may interfere with one or more of carrier, load, and/or suspension cable.

Securing an SLCS to other objects, such as to a carrier or to a load, is non-trivial. The other object may not be uniform, whether due to use or damage, and or may be manufactured with a tolerance that results in irregularities. Thrusters of the SLCS may further need to be moved, such as due to a size or configuration of a load or of a carrier, or for other reasons. Securement of the SLCS and or movement of thrusters often must or should be highly reliable to reduce potential for loss of life, injury, or harm to property that may result from failure of a securement or failure of a relocated thruster. In addition, securement of the SLCS to the other object or relocation of a thruster should be performed by a human or other system, potentially without the use of tools or with limited access to or ability to deploy tools, potentially in an environment that is unpredictable, unstable, or which otherwise includes obstacles to a party or system performing the securement, such as within a moving carrier, such as a helicopter, crane, fixed wing aircraft, on a building in the presence of other equipment, other people, with limited space, and the like.

Use of an SLCS, a carrier, and other components involved in control of a suspended load may be improved, made easier, less hazardous, and/or made more likely if the SLCS can be secured to another object in a way or in a manner which accommodates non-uniformity in the other object, wherein thrusters of the SLCS may be relocated in position, and wherein these objectives, e.g. securing the SLCS to another object and or relocating thrusters, can be performed with a minimal number of parts, minimal use of tools, and which results in a dependable securement to the other object and a dependable relocation of thrusters.

### BRIEF DESCRIPTION OF THE DRAWINGS

FIG. 1 illustrates a suspended load control system (“SLCS”), components to relocate thrusters of the SLCS, and components to secure the SLCS to another object from an isomorphic parallel projection view, in accordance with an embodiment.

FIG. 2 illustrates the SLCS of FIG. 1 with components hidden to reveal the function of these or other components, in accordance with an embodiment.

FIG. 3 illustrates a close oblique parallel projection view of components of the SLCS of FIG. 1, wherein the illustrated components comprise components to secure the SLCS to another object and components to relocate thrusters of the SLCS, in accordance with an embodiment.

FIG. 4 illustrates the close oblique parallel projection view of components of the SLCS of FIG. 3, with components hidden to reveal the function of these or other components, in accordance with an embodiment.

FIG. 5 illustrates a clasp to secure an SLCS to another object from an isomorphic parallel projection view, wherein the clasp is in a first posture, in accordance with an embodiment.

FIG. 6 illustrates the clasp of FIG. 5, wherein the clasp is in a second posture, in accordance with an embodiment.

FIG. 7 illustrates the clasp of FIG. 5, wherein the clasp is in the first posture and with components hidden to reveal the function of these or other components, in accordance with an embodiment.

FIG. 8 illustrates the clasp of FIG. 5, wherein the clasp is in a third posture, in accordance with an embodiment.

FIG. 9 illustrates the clasp of FIG. 5 from a first oblique parallel projection view, in accordance with an embodiment.

FIG. 10 illustrates the clasp of FIG. 5 from a second oblique parallel projection view, in accordance with an embodiment.

FIG. 11 illustrates components to secure an SLCS to another object, components to relocate thrusters of the SLCS, and two cross-sections illustrated further herein, in accordance with an embodiment.

FIG. 12 illustrates a first cross-section of FIG. 11, in accordance with an embodiment.

FIG. 13 illustrates a second cross-section of FIG. 11, in accordance with an embodiment.

FIG. 14 illustrates components to secure an SLCS to another object, components to relocate thrusters of the SLCS, in accordance with an embodiment.

FIG. 15 illustrates components of a clasp to secure an SLCS to another object, in accordance with an embodiment.

FIG. 16 illustrates the components of the clasp to secure an SLCS to another object of FIG. 15, with components hidden to reveal the function of these or other components, in accordance with an embodiment.

FIG. 17 illustrates the components of the clasp to secure an SLCS to another object of FIG. 16, with additional components, in accordance with an embodiment.

FIG. 18 illustrates a cross-section through a components of a clasp to secure an SLCS to another object, with additional components, in accordance with an embodiment.

FIG. 19 illustrates an SLCS secured to another object in an oblique parallel projection view, in accordance with an embodiment.

FIG. 20 illustrates a detail of a clasp of an SLCS securing the SLCS to another object, in accordance with an embodiment.

FIG. 21 schematically illustrates operational components of a suspended load control system including a remote interface, in accordance with an embodiment.

FIG. 22 illustrates an operational module of a suspended load control system including multiple modes or command states in accordance with an embodiment.

FIG. 23 illustrates a decision and control module of a suspended load control system in accordance with an embodiment.

FIG. 24 illustrates a data fusion and telemetry output module, in accordance with an embodiment.

FIG. 25 schematically illustrates electronic computer, hardware, and network connections among operational components of a suspended load control system in accordance with an embodiment.

### DETAILED DESCRIPTION

SLCS must typically be secured to one or more other objects, such as to a load. The load may comprise, for example, a rescue litter suspended on a suspension cable beneath a carrier such as a helicopter, construction materials suspended on a suspension cable system beneath a carrier such as a crane, and the like. Sometimes, the load may have a standard shape, size, and hardware configuration; for example, only a handful of rescue litters may be available to or be purchased by a provider of rescue services; for example, multiple units of a type of construction material may need to be transported on a construction site, e.g. wall panels, windows, girders, or the like.

Operations to handle suspended loads require crews and equipment to operate the carrier, to operate the SLCS, and to handle the load. The crew and equipment in suspended load operations may be specialized and or may require training; the suspended load operation may present risks of loss to the load, the carrier, the crew, adjacent people, and adjacent property. A party conducting a suspended load operation may strongly desire to reduce such risks of loss; for example, it is highly undesirable for a suspended load operation involving a load comprising a rescue litter and a human therein to fail; for example failure of a suspended load operation involving a load comprising construction materials may result in injury to or loss of life among a construction crew, significant property loss, and the like. Training and specialization of crew and equipment often limits flexibility of the crew and equipment to adapt to changing circumstances and or to reduce or manage risk of loss. Crew and equipment may be limited in capabilities by, for example, available power output by the crew and equipment relative to the mass, fragility of, or other characteristics of the load, by weather conditions, by safety and other equipment which may support or be incident to a suspended load operation, and the like.

Therefore, there is a strong incentive to make specialized equipment to secure an SLCS to standardized loads to take advantage of the standardization to create a corresponding standardized SLCS securement mechanism; standardization of the SLCS securement mechanism may allow it to have few parts, be reliable and may allow it to be easy to use. However, even when a load is supposed to have a standard shape, size, or hardware configuration, a specific instance of the load may deviate from the standard, whether due to fabrication tolerances, damage, circumstances of a suspended load operation, or customization. There is tension between the following: i) the desire to create a securement mechanism to secure and SLCS to a load (hereinafter an “SLCS securement mechanism”) that has few parts, is reliable, is easy to use, works with standardized loads, and ii) a requirement that the SLCS securement mechanism to accommodate variability in loads.

In addition, thrusters of an SLCS may need to be relocated within the SLCS. This may be to accommodate different loads, to increase or decrease a distance between the thrusters, e.g. to increase torque of the thrusters by placing them further apart, for storage or for use in a suspended load control operation, or for other reasons. Similar to an SLCS securement mechanism, equipment or components to relocate thrusters (hereinafter, a “thruster positioning mechanism”) should have the fewest number of parts possible, be reliable, should use a minimum of tools, and should be easy to use.

Disclosed herein is an SLCS securement mechanism and a thruster positioning mechanism. The SLCS securement mechanism and thruster positioning mechanism balance the above-noted competing objectives in that they have few parts, are reliable, use a minimum number of tools, are easy to use with a minimum of training, and, in the case of the SLCS securement mechanism, may secure an SLCS to a variety of loads, including to a rescue litter that may not or may no longer conform to a standard.

The disclosed thruster positioning mechanism allows thrusters of an SLCS to be relocated in manner that is reliable, wherein relocation may be performed by a human or other system, potentially without the use of tools or with limited access to or ability to deploy tools, potentially in an environment that is unpredictable, unstable, or which otherwise includes obstacles to a party or system performing the securement, such as within a moving carrier, such as a helicopter, crane, fixed wing aircraft, on a building in the presence of other equipment, other people, with limited space, and the like.

The disclosed thruster positioning mechanism may comprise a thruster prismatic joint and SLCS securement mechanism may comprise a clasp prismatic joint. A prismatic joint is a one degree of freedom kinematic pair. A prismatic joint constrains the motion of two bodies such that they translate along a common axis, generally without rotation; as used herein, “prismatic joint” may also encompass rotation about a common axis, whether exclusively or whether in conjunction with translation, as in a “cylindrical joint”. In an ideal world, the “one” degree of freedom of motion is perfect, though in a real world, there is always an additional degree of freedom of motion or rotation, though the additional degree of freedom of motion or rotation may not be significant or may be insignificant, compared to the one degree of freedom of motion.

The one degree of freedom of the prismatic joint of the thruster positioning mechanism may be referred to herein as a one degree of freedom of thruster translation. The one degree of freedom of the prismatic joint of the SLCS securement mechanism may be referred to herein as a one degree of freedom of clasp translation. The one degree of freedom of the prismatic joints of the disclosed thruster positioning mechanism and SLCS securement mechanism may be perpendicular to one another. The prismatic joints of the disclosed thruster positioning mechanism and SLCS securement mechanism may be constrained by a releasable body (encompassing a plurality of releasable bodies), wherein the releasable body precludes motion of the prismatic joint in the one degree of freedom. In an embodiment, a thruster releasable body for the thruster prismatic joint may comprise a bushing, wherein the thruster releasable body engages with the bushing to preclude the one degree of freedom of thruster translation. In an embodiment, the clasp prismatic joint may comprise the bushing and a bushing groove in the bushing; in an embodiment, the clasp releasable body for the clasp prismatic joint engages with the bushing groove to preclude the one degree of freedom of clasp translation. In an embodiment, the clasp releasable body comprises one or more of the clasp, a clasp base plate, a clasp base plate bolt, and a flange, wherein the clasp base plate bolt is to engage the flange with the bushing groove to preclude the one degree of freedom of clasp translation and releasably prevent shear force on the clasp from translating the clasp in the one degree of freedom of clasp translation. In an embodiment, the clasp releasable body comprises a clasp-position retaining pin, wherein the clasp-position retaining pin is to releasably engage with a hole of or secured to the SLCS and releasably prevent shear force on the clasp from translating the clasp in the one degree of freedom of clasp translation. In an embodiment, the clasp-position retaining pin is spring loaded. In an embodiment, the hole of or secured to the SLCS is a hole in the bushing.

The thruster prismatic joint may comprise at least a beam and a first thruster. As used herein, a “first thruster” may comprise an only thruster. The thruster prismatic joint may comprise a first thruster structure, hereinafter a first thruster structure, and a beam structure, hereinafter a beam structure, wherein the first thruster structure and the beam structure interlock and limit translation of the first thruster at least to the one degree of freedom of thruster translation, and wherein the releasable body is releasably securable to the first thruster and across the beam structure and, when so secured, releasably precludes motion of the first thruster in the one degree of freedom of thruster translation by releasably preventing shear force on the first thruster from translating the first thruster in the one degree of freedom of thruster translation.

In an embodiment, the thruster prismatic joint comprises a first thruster structure and a beam structure. In an embodiment, the first thruster structure comprises a protrusion and the beam structure comprises a beam groove corresponding to the protrusion and wherein the protrusion and the beam groove interlock and limit translation of the first thruster at least to the one degree of freedom of thruster translation in the suspended load control apparatus.

In an embodiment, the thruster prismatic joint comprises the first thruster releasably secured to a first beam and a second beam, including interposed between the first beam and the second beam. In an embodiment, the thruster positioning mechanism further comprises a second thruster releasable body and wherein the thruster prismatic joint further comprises the first thruster releasably secured to the first beam by a first thruster releasable body and the first thruster releasably secured to the second beam by a second thruster releasable body.

In an embodiment, the clasp comprises a clasp finger and a clasp finger engagement assembly, wherein the clasp finger engagement assembly is to releasably secure the clasp and the suspended load control apparatus to the load.

In an embodiment, the clasp finger is a first clasp finger, further comprising a second clasp finger and wherein the clasp finger engagement assembly comprises a clasp cam, wherein the clasp cam is to releasably reduce a distance between the first clasp finger and the second clasp finger, and a clasp release spring, wherein the clasp release spring is to increase the distance between the first clasp finger and the second clasp finger when the clasp cam is disengaged.

In an embodiment, the clasp further comprises a clasp pivot rod, wherein the clasp pivot rod is to allow at least the first clasp finger to rotate about the clasp pivot rod between at least a first clasp posture and a second clasp posture. In an embodiment, the first clasp posture is to secure the clasp to the load and the second clasp posture is to reduce a volume of space occupied by the clasp.

In an embodiment, the cam retaining trigger is to releasably retain the clasp cam when the clasp cam is engaged relative to the first clasp finger and the second clasp finger.

In this way, the disclosed SLCS securement mechanism is to secure an SLCS to other objects, such as to a carrier or to a load, wherein the other object may not be uniform. The disclosed SLCS securement mechanism is reliable, may be operated by a human or other system, potentially without the use of tools or with limited access to or ability to deploy tools, potentially in an environment that is unpredictable, unstable, or which otherwise includes obstacles to a party or system performing the securement, such as within a moving carrier, such as a helicopter, crane, fixed wing aircraft, on a building in the presence of other equipment, other people, with limited space, and the like.

In this way, the disclosed thruster positioning mechanism allows a thruster of an SLCS to be relocated by a human or other system, potentially without the use of tools or with limited access to or ability to deploy tools, potentially in an environment that is unpredictable, unstable, or which otherwise includes obstacles to a party or system performing the securement, such as within a moving carrier, such as a helicopter, crane, fixed wing aircraft, on a building in the presence of other equipment, other people, with limited space, and the like.

Furthermore, approaches to control suspended loads sometimes include countermeasures installed on a carrier. For example, some airframes, such as the Skycrane, have a rail system installed beneath a cabin to mitigate sway of a load, though, being remote from the suspended load, such rail system has margin effect. Some approaches to this problem involve automated countering algorithms in an aircraft's stability augmentation system, though, again, the effect of these measures is limited. At times, crew chiefs who remain within a helicopter during an extraction try to affect a suspended load by pushing or pulling a suspension cable from the helicopter; such efforts have limited effect and may be hazardous. Crane operators may move loads at slow rates to minimize pendular motion, may try to counter pendular motion with motion of the crane, or may use additional suspension cables or dedicated control cables (whether on the ground, neighboring structures, or on the crane); these measures increase costs, complexity, may not be effective, may make the undesired motion worse, and risk of failure. Some approaches to this problem absorb momentum of a suspended load by a reaction wheel or gyroscope, though such systems may be dangerous and may be subject to saturation of the reaction wheel or gyroscope. All such measures are inadequate and highly problematic.

In various embodiments, as described further herein, a suspended load control system addresses control of a load, independent from a carrier. The suspended load control system or suspended load stability system or suspended load control apparatus (referred to together as, “SLCS”) of this disclosure estimates state information such as mass of SLCS and load, cable length (between a carrier and load), inertia of SLCS and load, movement and rotation SLCS, and movement and rotation of the carrier, and thrust output from fans or other thrust sources. The SLCS further estimates disturbances, such wind force, sea state, and relative SLCS and carrier motion. This state information and disturbance forces are not “hard-wired” into the SLCS, but are and must be dynamically determined in order for the SLCS to change its behavior to address different operations and to address changing circumstances of a single operation.

With this complex state and disturbance model, the SLCS is able to control a load by dynamically exerting force from, for example, fans or propellers, as are found, for example, in high output electric ducted fans at, or near, a location of the load. High output electric ducted fans may be required in order to produce enough thrust to control a suspended load. Fans, propellers, electric ducted fans may be referred to herein as “EDFs”; EDFs and other sources of thrust or torque, such as reaction wheels, gyroscopes, jets, compressed air, hydrogen peroxide thrusters, rockets, and the like are collectively referred to herein as “thrusters”.

Vector thrust force produced by EDFs may be used to counteract yaw and pendular motion, may be used to translate a load horizontally, such as to avoid an obstacle or to move a load into an offset position relative to a normal lowest-energy hanging position or “fall line” below an attachment point of a suspension cable on a carrier, such as below an arm that holds the suspension cable. An SLCS may be used to control the fine location and rotation of a load, independently from the carrier. Telemetry output from an SLCS may be used to provide feedback to a carrier crew or to processes executed by systems in a carrier. For example, the cable length estimated by an SLCS, or a location of an SLCS and load relative to a target or relative to the carrier may be output to a crew which controls a hoist or to a process which controls a hoist or to the hoist directly.

Consequently, an SLCS enhances mission safety and improves performance of carrier and suspended load operations as the SLCS dynamically determines and controls fine location and rotation of a load, separate from motion of the carrier, and as the SLCS provides telemetry information which may be used during a suspended load operation.

Once deployed and in-use, the SLCS is agnostic with respect to the platform from which the load is suspended (e.g., the characteristics of a helicopter “ownship”, or a crane, etc.), as it independently and dynamically determines thrust necessary to stabilize the load or to direct the load in a desired direction, without producing thrust which might merely destabilize the load. This permits widespread adoption of the system regardless of carrier type, lowering cost and mitigating solution risks.

An SLCS can provide benefits to, for example, helicopter search and rescue, MEDEVAC, sling load operations, forest fire helicopters, crane operations, construction sling load operations, and civilian firefighting.

Control of an SLCS may require determining the position, orientation, and/or motion of an SLCS, of the carrier, and/or of a load; such information may be referred to herein as “state data”, “state information”, or “state parameters”. A subset of state information may be reported to another system; when so reported, such subset of state information may be referred to as “telemetry data” or “telemetry information”. Control of a carrier and/or components in a carrier, such as a winch or hoist which may be used in relation to an SLCS, may also be improved with state or telemetry information related to an SLCS, a load, and/or of a carrier. An SLCS may be used in contexts in which Global Position System (GPS) or other geolocation or radionavigation systems or other position and orientation systems are unavailable, are compromised, or are subject to latency. Redundancy in state and telemetry information may also be desirable to increase reliability in implementation of control systems and to decrease latency in providing telemetry information to such systems.

Control of an SLCS and a suspended load is different from control of other automated systems, such as cars and unmanned aerial vehicles, at least because an SLCS must dynamically and recursively estimate state information such as mass of SLCS and load, cable length, inertia of SLCS and load, movement and rotation SLCS, and movement and rotation of the carrier, as well as estimating disturbance forces, such as wind force, sea state, and relative SLCS and carrier motion.

Further disclosed herein are one or more apparatuses, systems, and/or methods to determine state information, including cable length, mass, position, orientation, and/or motion information of an SLCS, a carrier, and/or of a load and to provide state information as telemetry data to one or more control apparatuses, systems, and/or methods which may be remote from the SLCS. These apparatuses, systems, and/or methods are capable of determining state information at or by an SLCS, including in contexts in which radionavigation systems or other absolute and relative position and orientation systems are unavailable, are compromised, or are subject to latency or error.

As described further herein, these apparatuses, systems, and/or methods may integrate machine-vision information with other sensor information, such as from an inertial navigation system and from LIDAR (possibly a portmanteau of “light and radar” or an acronym for “light detection and ranging”), to localize an SLCS relative to a carrier or another object. Machine-vision information may be produced through image capture by cameras in an SLCS and object detection of the carrier and/or load in such images; when integrated with information from inertial navigation system and LIDAR systems, localized relative state information (including relative orientation and position of the carrier, load and/or SLCS, and separate heading vectors of carrier and SLCS within a localized coordinate system) may be developed with low latency and high reliability. When absolute state information is available, such as from GPS or another radionavigation or absolute positioning system, absolute and relative localized state information may be integrated. Integration of machine-vision information with information from inertial navigation, LIDAR, and/or absolute position systems may be performed using methods that comprise, for example, a Kalman Filter, such as an Unscented Kalman Filter (“UKF”) and state model.

As discussed, an SLCS and an attached load may rotate and/or may have a heading vector which follows a pendular path relative to a carrier's coordinate space. Relative and/or absolute state information developed according to the disclosure herein may be used to control or to enhance control of an SLCS or may be provided as telemetry to a carrier or a component within a carrier or to an object or persons on the ground or elsewhere.

Reference is now made in detail to the description of the embodiments illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein. For example, the embodiments set forth below are primarily described in the context of a helicopter sling load, search and rescue operations, and/or crane operations. However, these embodiments are illustrative examples and in no way limit the disclosed technology to any particular application or platform.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Certain elements are provided and element number; when an element number is followed by a letter, e.g. 105A and 105B, the elements are generally the same or substantially similar and may be referred to in general by the element number, without the letter. E.g. thruster 105A and thruster 105B are substantially similar and include substantially all of the same components in substantially all of the same locations, though, in this example, are a reflection of one another, rather than an identical a rotation of one another. For example, if thruster 105A and thruster 105B were an identical rotation of one another, power enclosure door 120A and power enclosure door 120B would be on opposite sides of thruster 105A and thruster 105B. Nonetheless thruster 105A and thruster 105B and other elements with the same element number and different letters may be referred to in general as thruster 105.

As used herein “releasable”, “connect”, “connected”, “connectable”, “disconnect”, “disconnected,” and “disconnectable” refers to two or more structures which may be connected or disconnected, generally without the use of tools (examples of tools including screwdrivers, pliers, drills, saws, welding machines, torches, irons, and other heat sources) or with the use of tools but in a repeatable manner (such as through the use of nuts and bolts or screws). As used herein, “attach,” “attached,” or “attachable” refers to two or more structures or components which are attached through the use of tools or chemical or physical bonding, but wherein the structures or components may not generally be released or re-attached in a repeatable manner. As used herein, “secure,” “secured,” or “securable” refers to two or more structures or components which are connected or attached.

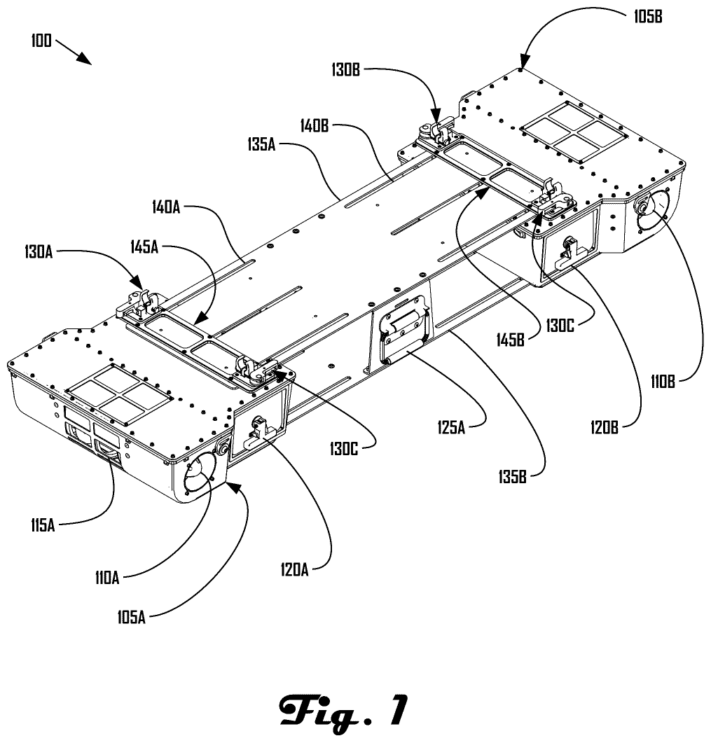

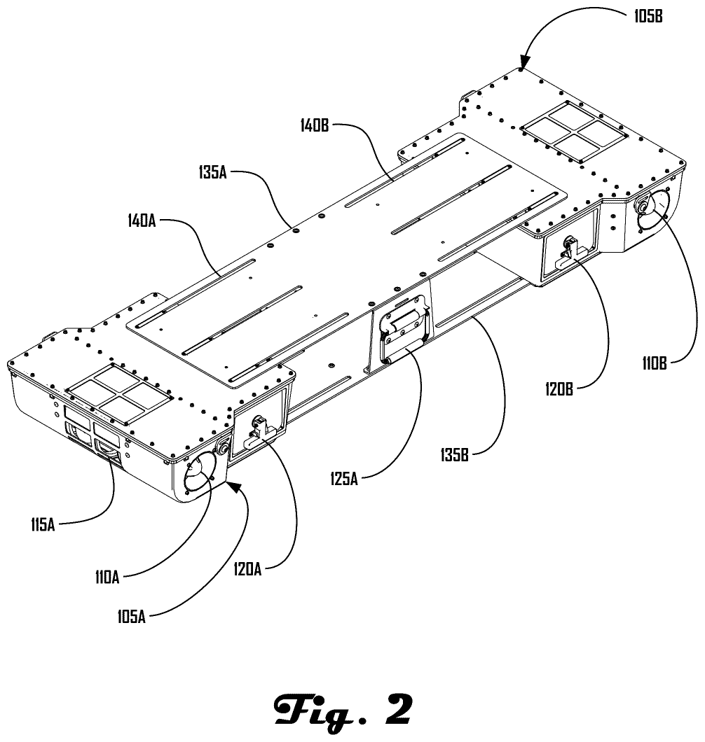

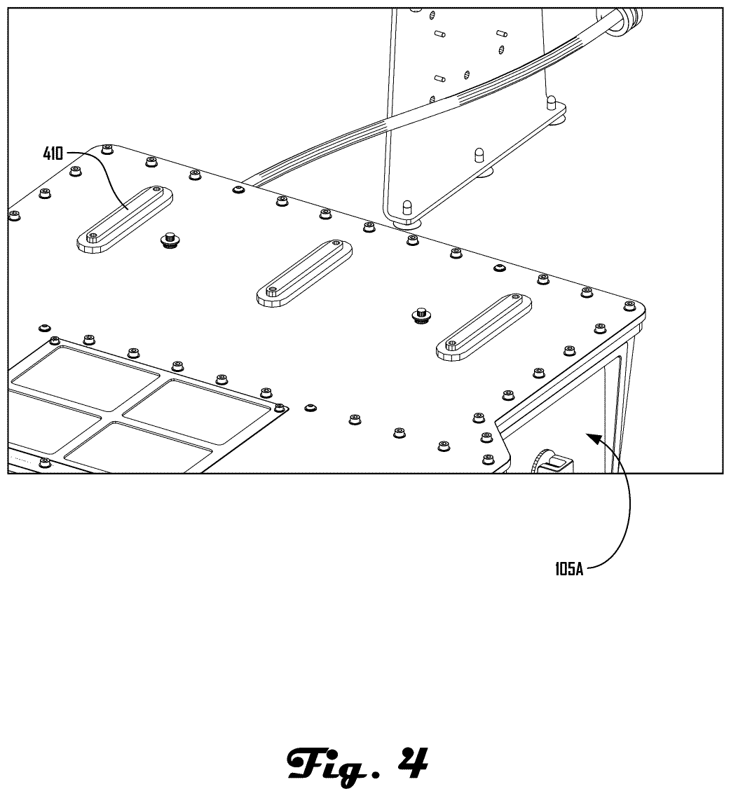

FIG. 1 to FIG. 4 illustrate SLCS 100 comprising components to relocate thrusters of the SLCS and components to secure SLCS 100 to another object, such as a load.

Illustrated elements comprise thruster 105A and thruster 105B. Thruster 105 comprises a thruster housing, wherein the thruster housing contains at least one thruster. In the example illustrated in thruster 105, the at least one thruster comprises a pair of opposing fans, wherein the fans comprise fans blade that are asymmetric and produce more thrust when rotated in one direction. Ducts around the fans may increase thrust and or reduce turbulence from the fans. Each fan may be driven by a separate motor or a pair of fans may be driven by one motor. Symmetric thrusters may also be used, including one or a pair of symmetric thrusters driven by one motor or by a pair of motors. In the example of FIG. 1 to FIG. 4, thruster 105 comprises a pair of opposing ducted fan 110, each of which has a separate motor. Air or other thrust fluid for ducted fan 110 may be drawn in through intake 115.

Illustrated elements further comprise a thruster positioning mechanism, wherein the thruster positioning mechanism comprises a prismatic joint, e.g. thruster prismatic joint, comprising beam 135A and beam 135B, with thruster 105A and thruster 105B between beam 135A and beam 135B. In the illustrated examples, beam 135 comprises a plate, for example, a plate of metal, of plastic or composite, e.g. fiberglass, aramid, carbon fiber and a resin or plastic, or the like. In embodiments, the beam may comprise an I-beam or tube, wherein the tube has a cross section comprising at least one of an ellipse, including a circle, and a rectangle, including a square.

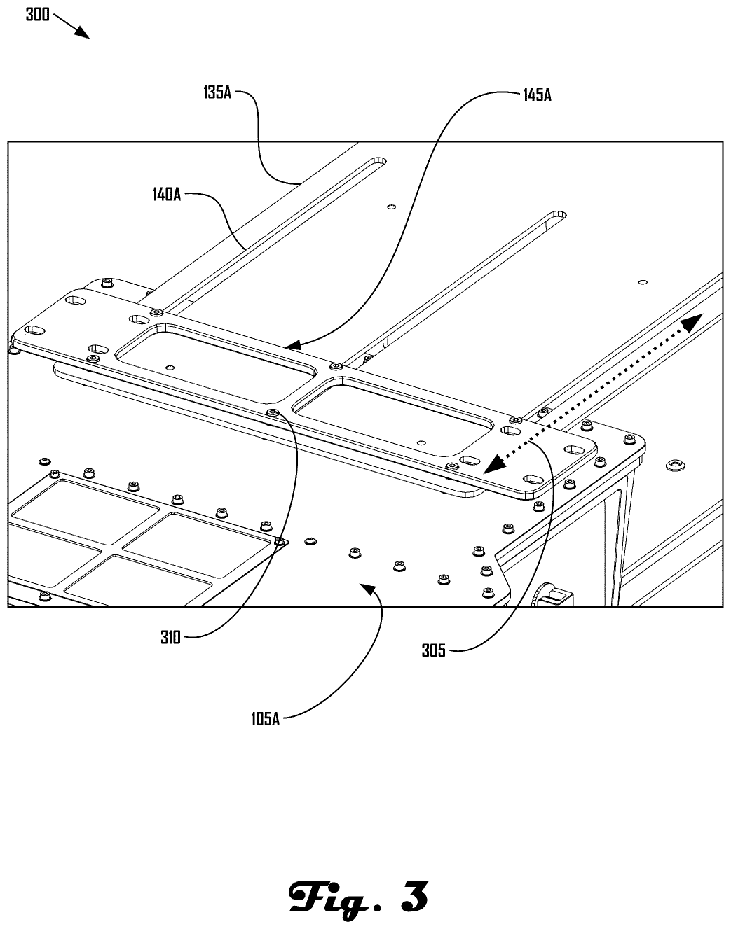

In the illustrated examples, the thruster prismatic joint further comprises a structure in or secured the beam, also referred to as a beam structure. In the illustrated examples, the beam structure comprises beam groove 140A, beam groove 140B, and other beam grooves (not numbered). In the illustrated examples, beam groove 140 interlocks with a structure in or secured to thruster 105, also referred to as a thruster structure. In the illustrated examples, the thruster structure comprises protrusion 410. Protrusion 410 interlocks with beam groove 140 and allows thruster 105 one degree of freedom of thruster translation 305, e.g. as illustrated in FIG. 3.

The thruster positioning mechanism comprises bushing 145. Bushing 145 may be releasably secured to thruster 105, e.g. at the thruster structure, e.g. at protrusion 410, by bolt 310. When loosely fitted, bolt 310 may allow bushing 145 to act as part of thruster prismatic joint, holding bushing against beam 135 and only allowing thruster 105 one degree of freedom of thruster translation 305. When tightly fitted, bolt 310 may allow bushing 145 to act as a thruster releasable body, wherein the thruster releasable body releasably generates a compressive force on and a friction between bushing 145, beam 135, and thruster 105, wherein the compressive force and the friction, when generated, is to preclude motion of the thruster 105 in the one degree of freedom of thruster translation 305 and thereby releasably prevents shear force on thruster 105 from translating thruster 105 in SLCS 100.

In embodiments, the thruster prismatic joint may be formed from other components, such as if beam 135 and or the beam structure comprises a pipe and the thruster structure comprises a corresponding pipe which fits inside or outside of the pipe of the beam structure, wherein the pipe(s) may have a cross section comprising at least one of an ellipse, including a circle, and a rectangle, including a square. In embodiments, the thruster prismatic joint may be formed from other components, such as an I-beam and interlocking structures.

In the illustrated examples, SLCS 100 comprises handle 125, for handling or transporting SCS 100. In the illustrated examples, SLCS 100 comprises power enclosure door 120. Behind power enclosure door 120 may be a power supply, e.g. batteries, connection to a wireline power supply, fuel for a combustion engine for the thrusters, and the like.

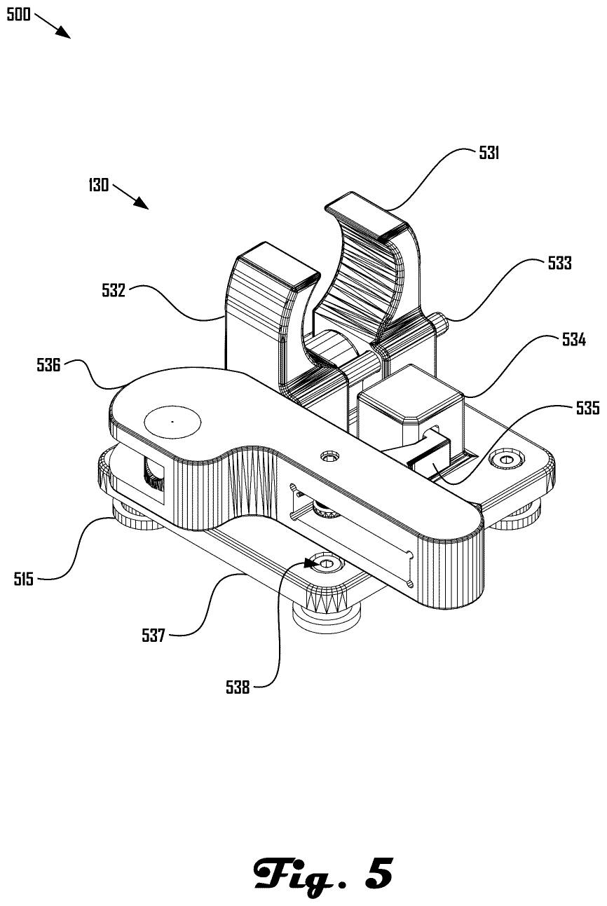

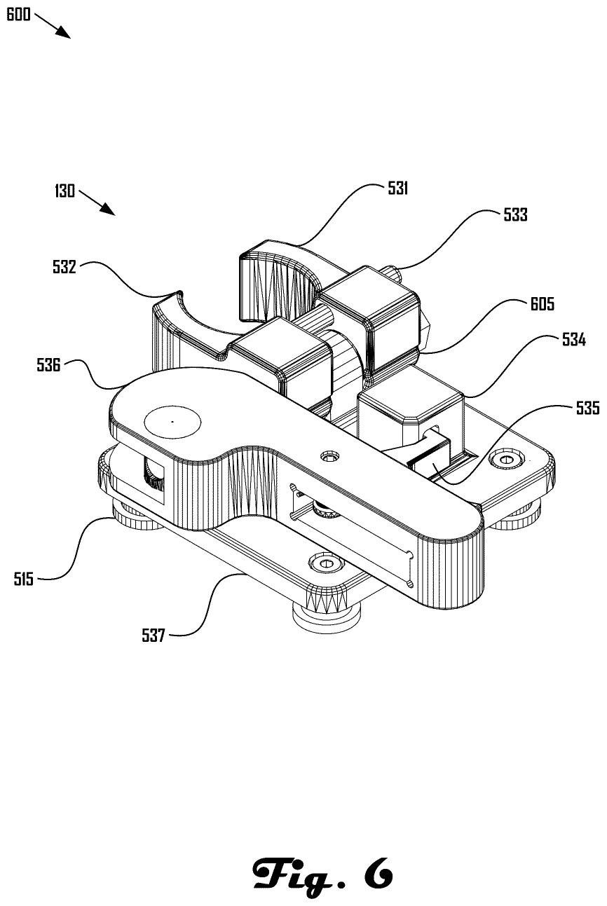

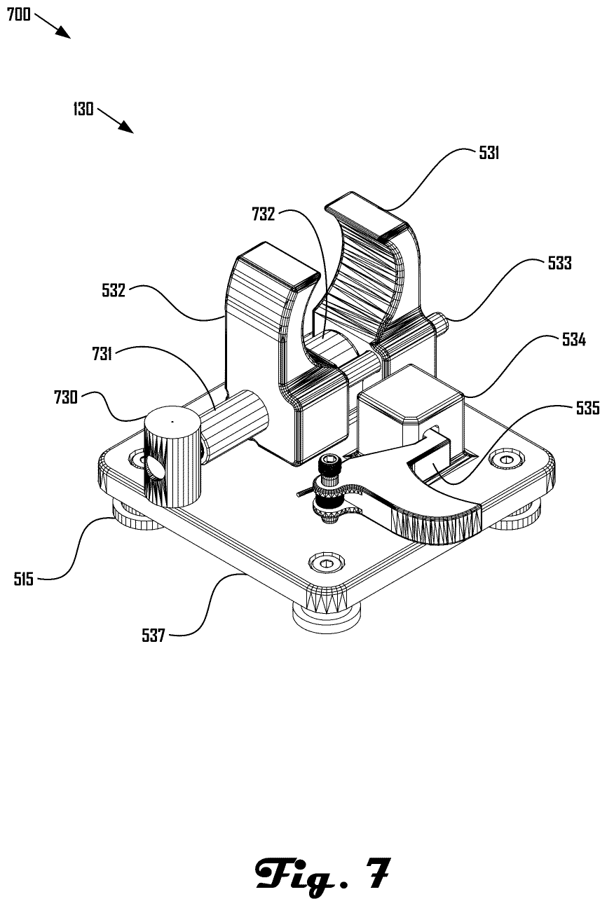

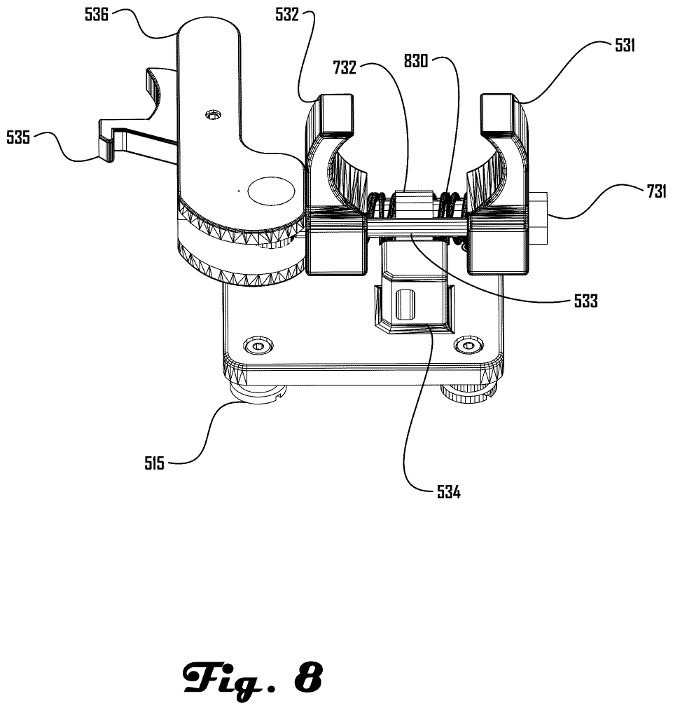

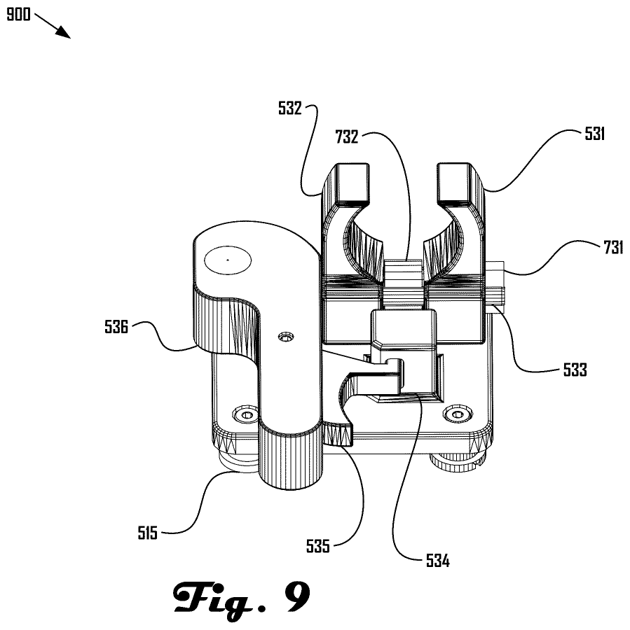

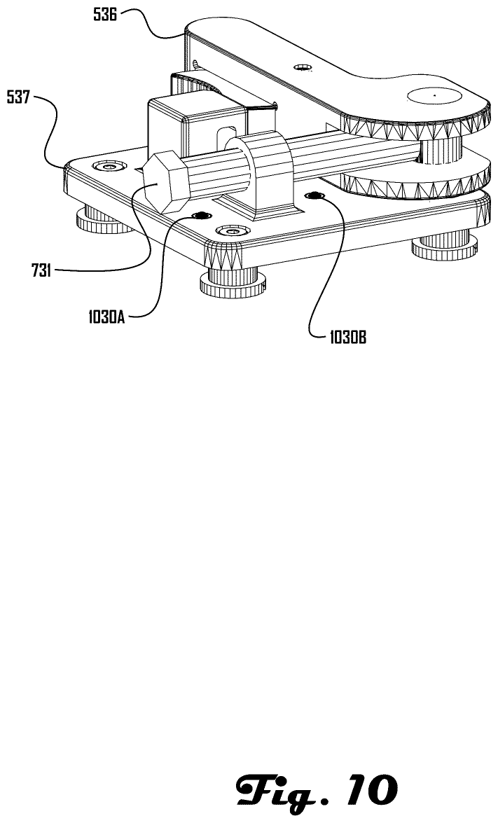

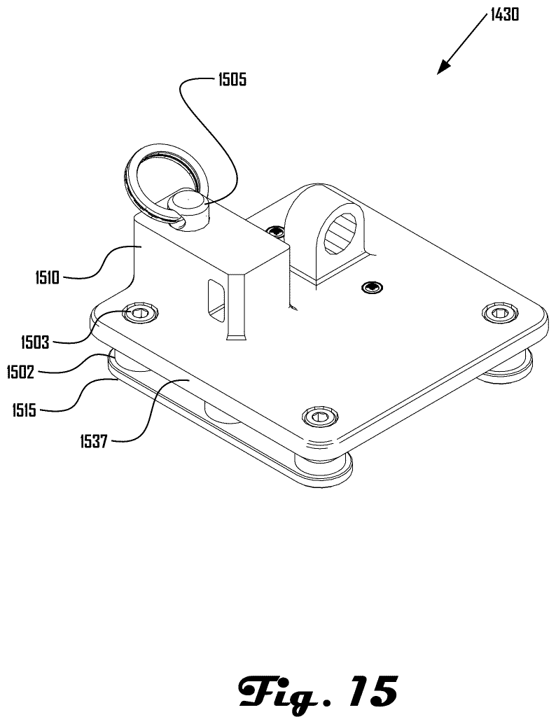

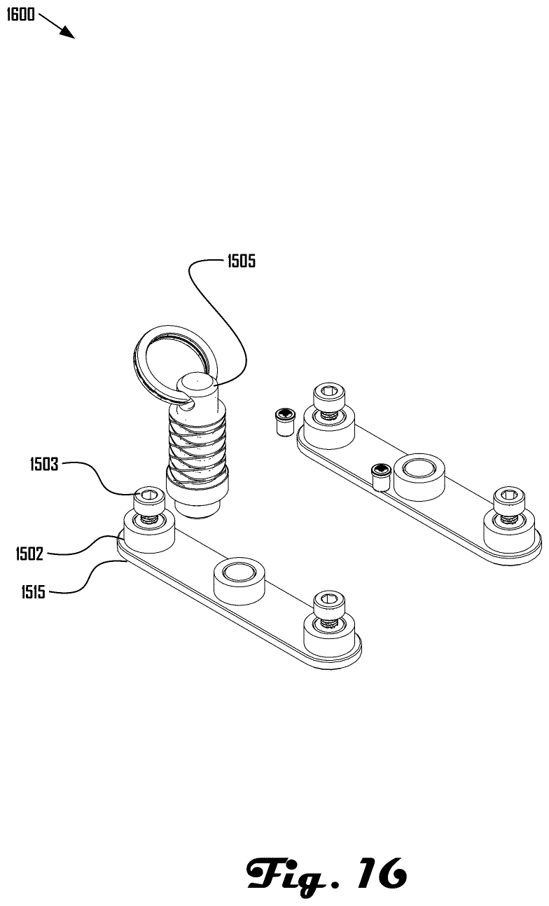

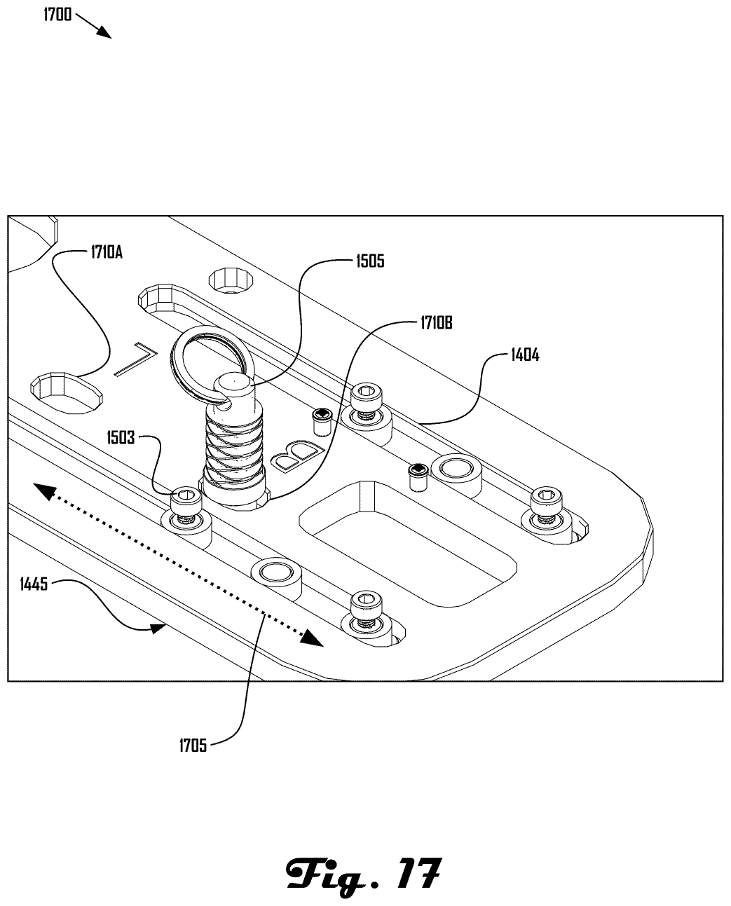

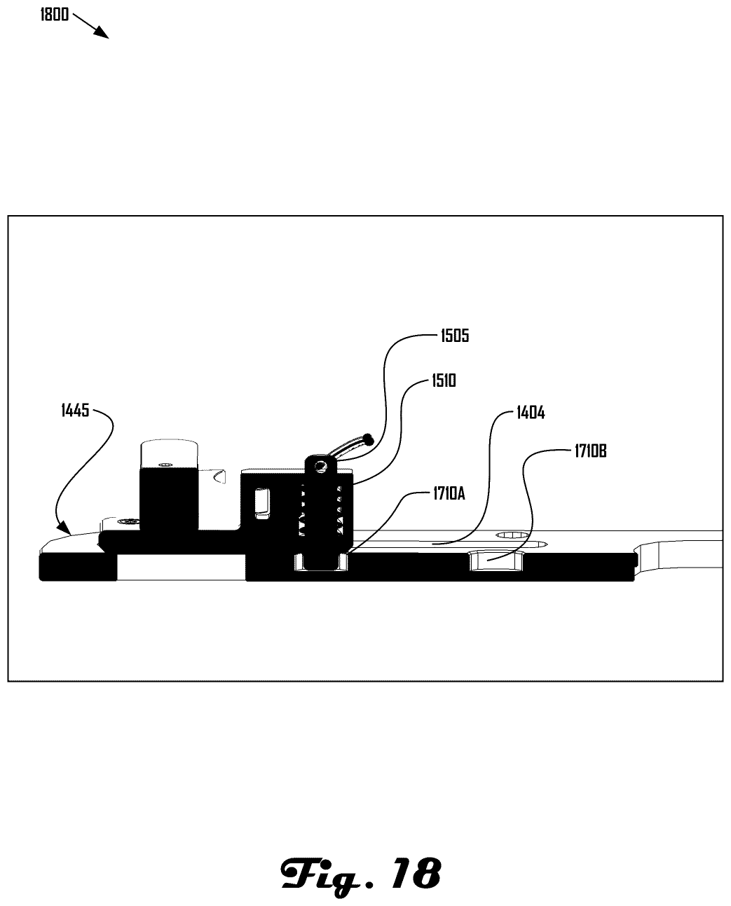

FIG. 5 through FIG. 18 illustrate example embodiments of an SLCS securement mechanism to releasably secure an SLCS, e.g. SLCS 100, to a load.

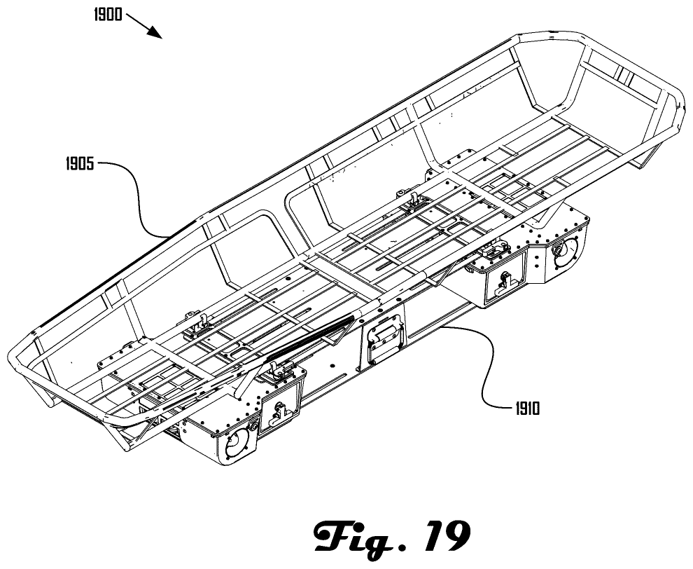

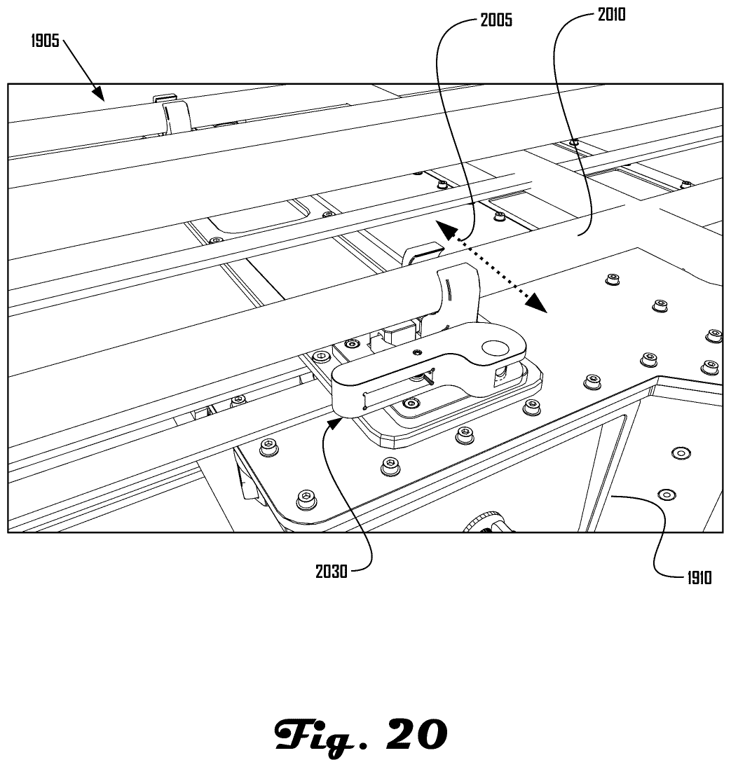

As illustrated in FIG. 19 and FIG. 20, load 1905 may be a rescue litter or “litter” or the like. As illustrated in FIG. 19 and FIG. 20, SLCS 1910 encompasses the examples illustrated with respect to FIG. 1 through FIG. 18 and may be secured beneath load 1905, such as to structures of load 1905, such as frame 2010 of load 1905, via SLCS securement mechanism 2030. As illustrated in FIG. 20, SLCS securement mechanism 2030 comprises a clasp prismatic joint of the like disclosed herein, wherein the clasp prismatic joint provides one degree of freedom of clasp translation 2005, to accommodate frame 2010; as noted, frame 2010 may have fabrication irregularities relative to a standard litter, may have suffered damage, or otherwise may require that SLCS securement mechanism 2030 have one degree of freedom of clasp translation 2005. In other embodiments, the load may comprise materials at a construction site. In other embodiments, the SLCS may be secured above or beside the load.

In the examples illustrated in FIG. 5 through FIG. 18, the SLCS securement mechanism comprises a clasp prismatic joint, a clasp releasable body, wherein the clasp releasable body comprises clasp 130 and or clasp 1430, wherein clasp 130 and or clasp 1430 is to releasably secure SLCS 100 and or SLCS 1910 to a load, wherein the clasp prismatic joint is to provide clasp 130 and or clasp 1430 at least one degree of freedom of clasp translation 305 and or one degree of freedom of clasp translation 1705 in the suspended load control apparatus, wherein the clasp releasable body is to releasably preclude motion of the clasp in the one degree of freedom of clasp translation provided by the clasp prismatic joint, and wherein the SLCS is to control the load suspended below the carrier on a suspension cable.

In these examples, the clasp releasable body comprises clasp 130 releasably secured to flange 515 and in bushing grove 1304 and, when secured, is to releasably preclude motion of clasp 130 in one degree of freedom of clasp translation 305 provided by the clasp prismatic joint. In these examples, the clasp releasable body comprises clasp 1430 releasably secured to flange 1515 and in bushing grove 1404 and, when secured, is to releasably preclude motion of clasp 1430 in one degree of freedom of clasp translation 1705 provided by the clasp prismatic joint.

In these examples, one degree of freedom of clasp translation 305 and or one degree of freedom of clasp translation 1705 are perpendicular to one another. In these examples, beam groove 140 and bushing groove 1304 and bushing groove 1404 are perpendicular to one another.

In the examples illustrated in FIG. 5 through FIG. 13, clasp 130 comprises clasp base plate 537, wherein clasp base plate 537 is to be releasably secured to bushing 145. In these examples, bushing groove 1304 within bushing 145 provides one degree of freedom of clasp translation 1305 when clasp base plate bolt 538 and flange 515 engage with bushing groove 1304. In these examples, the clasp releasable body comprises one or more of clasp 130, clasp base plate 537, clasp base plate bolt 538, and flange 515, wherein clasp base plate bolt 538 is to engage flange 515 within bushing groove 1304 to preclude one degree of freedom of clasp translation 305 and releasably prevent shear force on clasp 130 from translating clasp 130 in one degree of freedom of clasp translation 305.

In the examples illustrated in FIG. 5 through FIG. 13, clasp 130 comprises a clasp finger engagement assembly, wherein the clasp finger engagement assembly is to releasably secure clasp 130 and SLCS 100 to the load. In these examples, the clasp finger engagement assembly comprises clasp finger 531, clasp finger 532, clasp cam 536, clasp cam pivot 730, and clasp release spring 830. In these examples, a human may engage or disengage clasp cam 536, without use of tools, wherein clasp cam 536 is to pivot about clasp cam pivot 730 to releasably reduce a distance between the clasp finger 531 and clasp finger 532 and wherein clasp release spring 830 is to increase a distance between the clasp finger 531 and clasp finger 532 when clasp cam 536 is disengaged. In these examples, clasp 130 further comprises clasp pivot rod 731, wherein clasp pivot rod 731 is to pivot about clasp pivot rod bracket 732 and allow at least clasp finger 531 to rotate about clasp pivot rod 731 between at least first clasp posture 500 and second clasp posture 600. In an embodiment, first clasp posture 500 is to secure clasp 130 to the load and second clasp posture 600 is to reduce a volume of space occupied by clasp 130. In an embodiment, posture retaining groove 605 and spring-loaded posture retainer 1030 are to retain clasp finger 531 and clasp finger 532 in first clasp posture 500; a similar posture retaining groove and spring-loaded posture retainer 1030 may also maintain clasp 130 in second clasp posture 600. In these examples, clasp orientation rod 533 is to maintain an orientation of clasp finger 531 relative to clasp finger 532. In these examples, cam retaining trigger 535 is to releasably retain clasp cam 536, by engagement of cam retaining trigger 535 with cam retaining trigger block 534, when clasp cam 536 is engaged relative to clasp finger 531 and clasp finger 532, to prevent or reduce a likelihood that clasp cam 536 may be accidentally released and to thereby prevent or reduce a likelihood that clasp 130 will be accidentally released from a load.

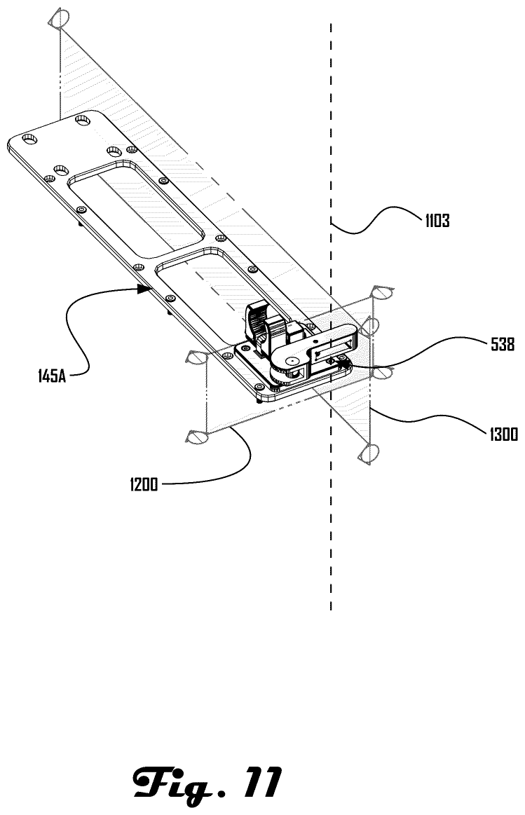

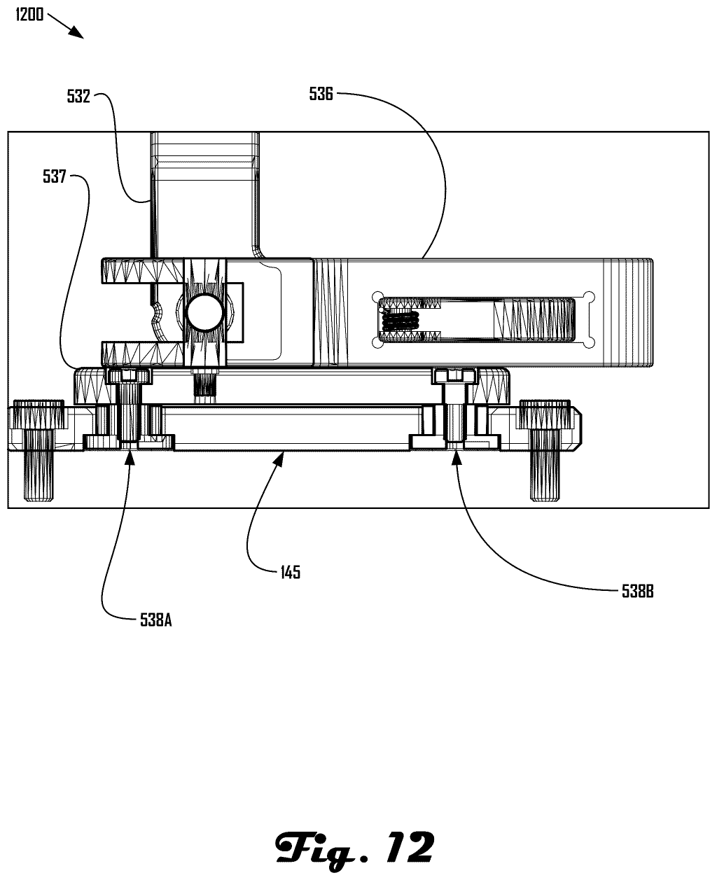

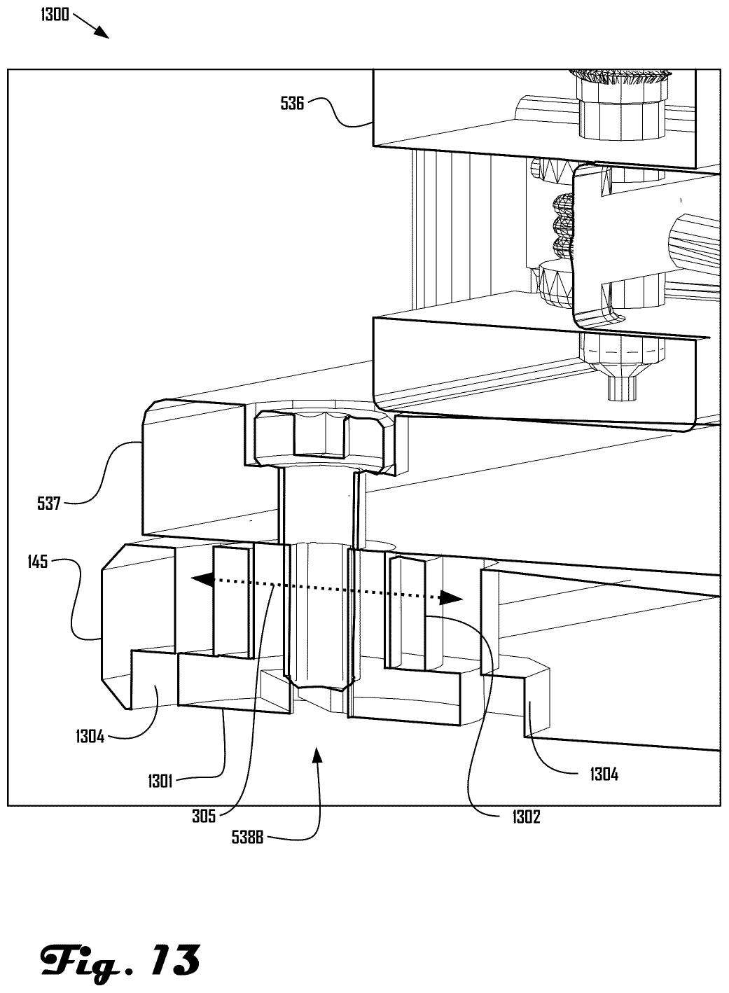

FIG. 11 illustrates cross section 1200, illustrated further in FIG. 12, and cross section 1300, illustrated further in FIG. 13, both of which pass through centerline 1103 through claps base plate bolt 538.

In examples illustrated in FIG. 5 through FIG. 13, spacer 1302 is not taller than bushing groove 1304 is deep, which thereby allows clasp 130 to act as a clasp releasable body when clasp base plate bolt 538 is fully tightened.

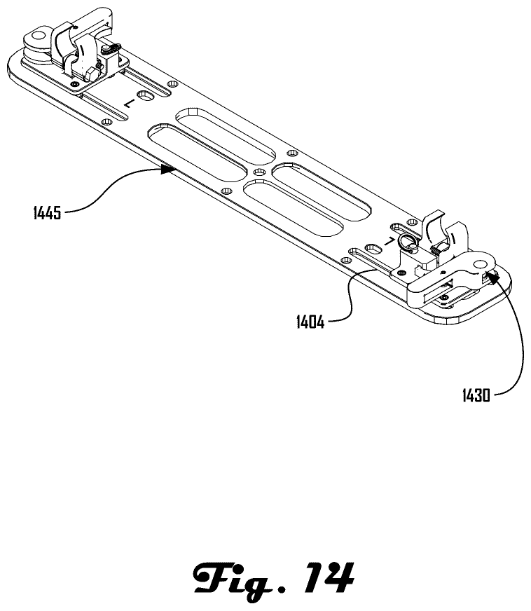

In examples illustrated in FIG. 14 through FIG. 18, bushing groove 1404 within bushing 1445 provides one degree of freedom of clasp translation 1705 when clasp base plate bolt 1503 and flange 1515 engage with bushing groove 1404. Bushing groove 1404 may be longer than bushing groove 1304. In examples illustrated in FIG. 14 through FIG. 18, spacer 1502 may be slightly taller than bushing groove 1404 is deep, which thereby prevents clasp 1430 from acting as a clasp releasable body, notwithstanding that clasp base plate bolt 1503 may be fully tightened. In this example, the clasp releasable body comprises clasp-position retaining pin 1505, wherein the clasp-position retaining pin 1505 is to releasably engage with hole of or secured to SLCS 1710 and releasably prevent shear force on the clasp from translating clasp 1430 in one degree of freedom of clasp translation 1705. Hole of or secured to SLCS 1710 may be sized to allow clasp 1430 to translate within one degree of clasp translation 1705, notwithstanding that clasp base plate bolt 1503 may be fully tightened. In an embodiment, clasp-position retaining pin 1505 is spring loaded as is within block 1510, wherein block 1510 both serves to hold clasp-position retaining pin 1505 and to act as a cam retaining trigger block for a cam of clasp 1430. In an embodiment, hole of or secured to SLCS 1710 is a hole in bushing 1445.

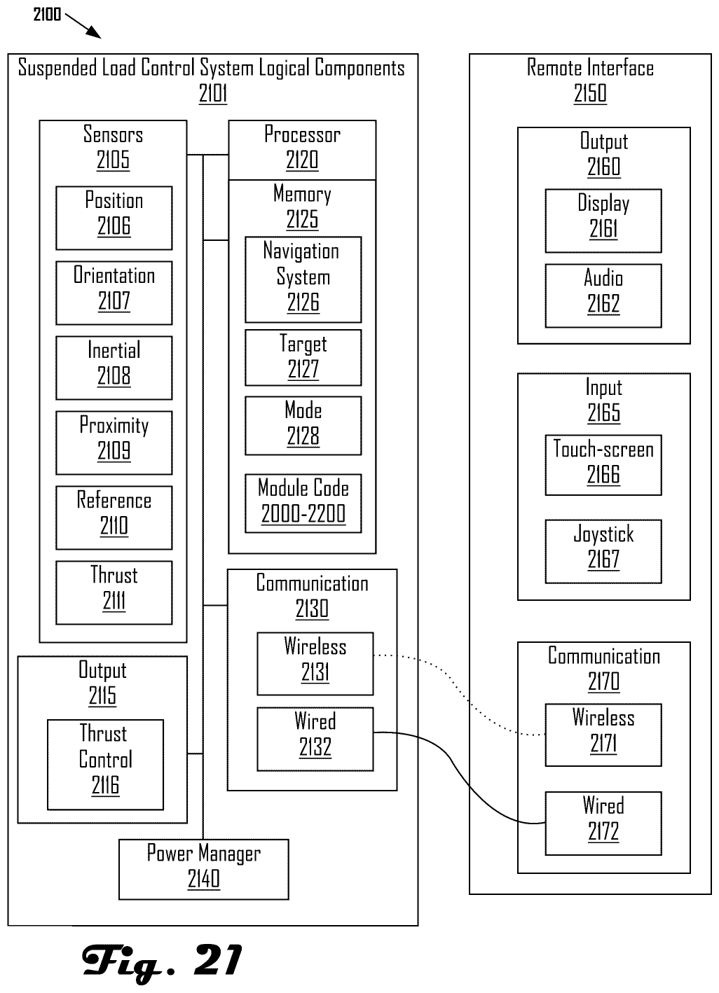

FIG. 21 schematically illustrates logical components of SLCS 100 including SLCS logical components 2101 and remote interface 2150 in accordance with one embodiment.

Interactive display or remote interface 2150 may be a computational unit that can be self-powered or hardwired into an airframe or other carrier. Display or remote interface 2150 receives data, such as telemetry data, from an SLCS, e.g., wirelessly. The data from the SLCS may be parsed and converted to visual cues or visual information and displayed on display 2161.

An example of an embodiment of a user interface (UI) of interactive display or remote interface 2150. For example, a label in the UI may represent a location of an SLCS and a load. The UI may further communicate the height or distance of the SLCS below the carrier, such as via the size of label 410 and/or in text, such as “HL: −90”, which may mean that the length of suspension cable is 90′ below the carrier. As discussed further herein, the length of suspension cable below the carrier may be calculated by, for example, data fusion and telemetry output module 2100, based solely on sensor information generated at the SLCS, such as SLCS 105. The UI may further communicate the height or distance of the SLCS and/or load above the ground, such as via a color of a label, through another graphical representation, and/or in text, such as “AGL: +15”, which may mean that the SLCS and/or load is 15′ above ground level. The UI may further communicate the absolute position of the carrier and/or of the SLCS and/or load, such as “LAT: 44.244167 LON: 7.76944”.

The UI also communicates an operator's desired command states to an SLCS, as discussed herein. Desired command states may be communicated verbally, by touching (including repeated or sustained touch) of UI, by dragging objects on UI, by pushing buttons, whether graphical buttons on a touchscreen or physical buttons, by entry of text commands, through a keyboard, and the like.

The interactive display or remote interface 2150 is in communication with SLCS logical components 2101 via communication systems 2170, which may be wireless 2171 or wired 2172. Output 2160 from remote interface 2150 may include information displayed on a screen or display 2161, and audio 2162. Input 2165 to remote interface 2150 to control the SLCS may include commands conveyed through a touchscreen 2166, a joystick 2167, a microphone, a camera, button, or the like. In various embodiments, remote interface 2150 and/or UI may comprise one or more physical and/or logical devices that collectively provide the functions described herein.

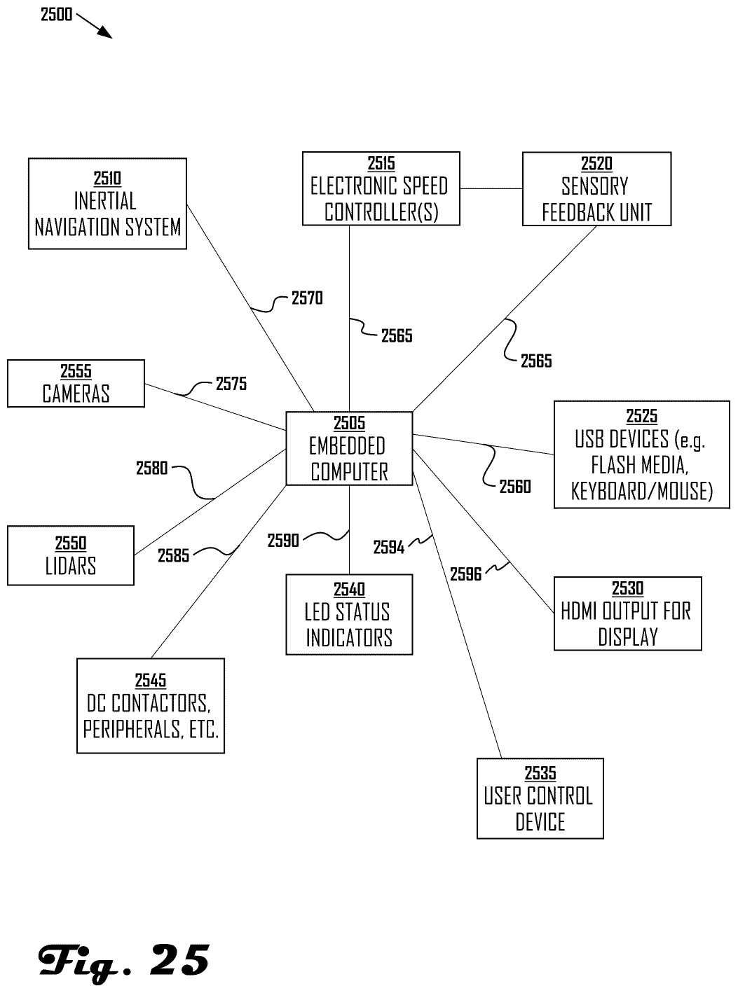

As illustrated in the embodiment illustrated in FIG. 21, within SLCS logical components 2101 are sensor suite 2105, which may include position sensors 2106, orientation sensors 2107, inertial sensors 2108, proximity sensors 2109, reference location sensors 2110, and thrust sensors 2111. Examples of embodiments of such sensors are discussed further herein, such as in relation to IMU, absolute position measurement systems, and as discussed in relation to FIG. 25, such as inertial navigation system 2510, cameras 2555, LIDARS 2550, DC contactors, peripherals, etc. 2545, and sensory feedback unit 2520.

SLCS processor 2120 may include one or more processor and/or microcontrollers. An example of a processor and/or microcontroller is embedded computer 2505 of FIG. 25.

SLCS memory 2125 may generally comprise a random access memory (“RAM”), a read only memory (“ROM”), and a permanent non-transitory mass storage device, such as a disk drive or SDRAM (synchronous dynamic random-access memory).

SLCS memory 2125 may store program code for modules and/or software routines, such as, for example, navigation system 2126, operational module 2200, decision and control module 2000, and data fusion and telemetry output module 2100, as well as data or information used by modules and/or software routines, such as, for example, target data 2127, and mode or command state information 2128.

Memory 2125 may also store an operating system. These software components may be loaded from a non-transient computer readable storage medium into memory 2125 using a drive mechanism associated with a non-transient computer readable storage medium, such as a floppy disc, tape, DVD/CD-ROM drive, memory card, or other like storage medium. In some embodiments, software components may also or instead be loaded via a mechanism other than a drive mechanism and computer readable storage medium (e.g., via a network interface.

Memory 2125 may also comprise a kernel, kernel space, user space, user protected address space, and a datastore.

Memory 2125 may store one or more process (i.e., executing software application(s)). Process may be stored in user space. A process may include one or more other process. One or more process may execute generally in parallel, i.e., as a plurality of processes and/or a plurality of threads.

Memory 2125 may further store an operating system and/or kernel. The operating system and/or kernel may be stored in kernel space. In some embodiments, the operating system may include a kernel. The operating system and/or kernel may attempt to protect kernel space and prevent access by certain of the processes.

The kernel may be configured to provide an interface between user processes and circuitry associated with embedded computer 2505. In other words, the kernel may be configured to manage access to embedded computer 2505, a chipset, I/O ports and peripheral devices by processes. The kernel may include one or more drivers configured to manage and/or communicate with elements of operational components of SLCS 100 and 2500 (i.e., embedded computer 2505, chipset, I/O ports and peripheral devices).

Processor 2120 may also comprise or communicate via a bus and/or a network interface with memory 2125 or another datastore. In various embodiments, such a bus may comprise a high speed serial bus, and a network interface may be coupled to a storage area network (“SAN”), a high speed wired or wireless network, and/or via other suitable communication technology.

SLCS logical components 2101 may, in some embodiments, include many more components than as illustrated. However, it is not necessary that all components be shown in order to disclose an illustrative embodiment.

The data groups used by modules or routines in memory 2125 may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, references to other database entries, joins, conditional logic, tests, and similar.

Communication system(s) 2130 may include wireless system(s) 2131 such as the wireless transceiver, and wired system(s) 2132. SLCS output 2115 includes thrust control 2116 via thruster controllers. Power managing systems 2140 regulate and distribute the power supply from, e.g., the batteries. One or more data connectors, data buses, and/or network interfaces may connects the various internal systems and logical components of the SLCS. Examples of data connectors and/or data bus are illustrated in FIG. 25, at data connector elements 2565 to 2596.

Aspects of the system can be embodied in a specialized or special purpose computing device or data processor that is specifically programmed, configured, or constructed to perform one or more of the computer-executable instructions explained in detail herein. Aspects of the system can also be practiced in distributed computing environments where tasks or modules are performed by remote processing devices that are linked through a communications network, such as a local area network (LAN), wide area network (WAN), the Internet, or any radio frequency communication technology. Data from an SLCS may be of very low bandwidth and may not be restricted to a frequency or communication protocol. In a distributed computing environment, modules can be located in both local and remote memory storage devices. As schematically illustrated in FIG. 21, SLCS logical components 2101 and remote display interface 2150 may be connected by wired or wireless networks.

An SLCS may work with a remote positional unit or target node of a suspended load control system in accordance with one embodiment. The remote positional unit or target node may comprise an external sensor suite or beacon configured to communicate, such as wirelessly, with the SLCS as a positional reference. If the SLCS is considered the primary sensor suite, a secondary sensor suite location can be the platform or carrier from which the cable is suspended, and a tertiary sensor suite location can be a location of interest for the load (e.g., for positioning to obtain or deliver the load).

A remote positional unit can include a positional transceiver configured to communicate with the SLCS via its wireless transceiver and provide a positional reference. For example, a remote positional unit can be attached to a helicopter ownship or crane below which a load may be suspended.

In some embodiments, the remote positional unit or target node may be made of durable polymer or plastic, large enough to fit into a hand. The remote positional unit or target node may have an external antenna. The remote positional unit or target node may be attached to, e.g., the helicopter by magnets, bolts, or any other attachment mechanism. The remote positional unit or target node may be dropped to a location on the ground or attached to, e.g., a life preserver or other flotational device, a rescuer, a load to be picked up, a location for a load to be delivered, or an operational specific location.

Aspects of the system can be embodied in a specialized or special purpose computing device or data processor that is specifically programmed, configured, or constructed to perform one or more of the computer-executable instructions explained in detail herein, such as embedded computer 2505. Aspects of the system can also be practiced in distributed computing environments where tasks or modules are performed by remote processing devices that are linked through a communications network, such as a local area network (LAN), wide area network (WAN), or the Internet. In a distributed computing environment, modules can be located in both local and remote memory storage devices. As schematically illustrated in FIG. 21, SLCS logical components 2101 and remote display interface 2150 are connected by a wired or wireless network.

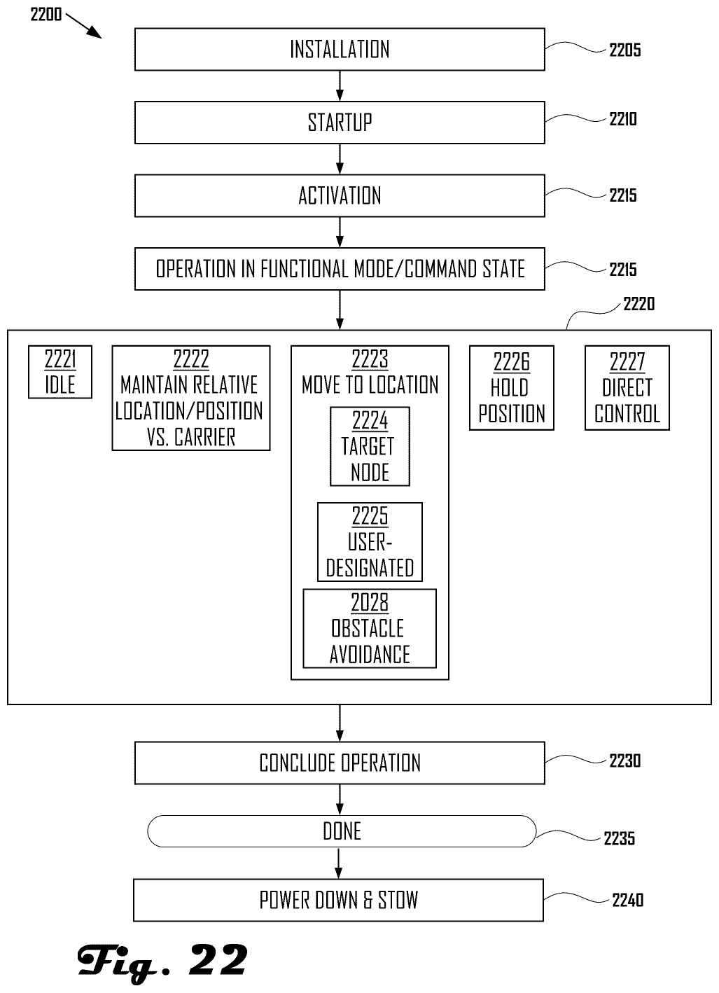

FIG. 22 illustrates an operational module 2200 of a suspended load control system (“SLCS”) including multiple modes or command states in accordance with one embodiment. Instructions of, or which embody, decision and operational module 2200 may be stored in, for example, memory 2125, and may be executed or performed by, for example, processor 2120, as well as by electrical circuits, firmware, and other computer and logical hardware of SLCS with which operational module 2200 may interact. In embodiments, computer processors and memory to perform some or all of operational module 2200 may be remote from SLCS, such as in an auxiliary computer in, for example, a carrier.

In block 2205, the SLCS apparatus may be installed onto a load and/or cable from which the load will be suspended. The SLCS apparatus need not be powered for installation.

In block 2210, the SLCS in the apparatus may be started up and operational module 2200 activated, if it is not already operating. In some embodiments, operational module 2200 may be initialized by the press of a button located on the face of the center module of the SLCS. Near the accessible external button which may initialize operational module 2200, another button may be present that allows for immediate system shut down when pressed. In addition to the initialization interface on the center module, operational module 2200 may be initialized by an operator not directly next to the system. One or more external operators, including but not limited to a rescuer on the end of the cable, may initialize operational module 2200 by pressing a button on one or more interactive displays 2161 linked wirelessly to operational module 2200.

One or more modules of a complete SLCS, such as physically separated control unit, fan unit, and the like, may be started up in block 2210 and may be paired to function together. During block 2210, operational module 2200 may determine a relative orientation of fan units which operational module 2200 is to control. This determination may be based on sensor information from the fan units, such as a compass heading sampled from each fan unit. This determination may be performed to adjust for fan units which are not parallel to one another, as may be the case when a modular SLCS is deployed on an irregular load, such as a rope or webbing enclosed load, and the fan units may not be parallel. This determination may be used in, for example, block 2045, with respect to fan mapping and determination of an actuator mix. This determination may not be necessary when the SLCS is in a rigid frame and the fan units may be presumed to be, for example, parallel to one another. This determination may produce an error condition if the fan units are not within an acceptable orientation range.

In block 2215, operational module 2200 is activated in and/or receives a functional mode or command state selected by the operator.

In block 2220 and a functional mode or command state, operational module 2200 may perform or call suspended load control decision and control module 2000 as a subroutine or submodule, to implement a functional mode or command state. The functional modes or command states of the system are and perform the following:

Idle mode 2221: all internal systems of the SLCS are operating (e.g., operational module 2200 observes motion of the SLCS and calculates corrective action), but thrusters are shut off or maintain an idle speed only, without action to affect the motion of the load.

Maintain relative position relative to ownship mode 2222: stabilizes the SLCS with respect to a slung origin point. For example, when the SLCS is suspended with a load below an arm of a helicopter, the SLCS will stay directly below the arm. Maintain relative position relative to ownship mode 2222 localizes the ownship motion and performs the corrective actions necessary to critically damp any other suspended load motion. If the ownship is traveling at a low speed, maintain relative position relative to ownship mode 2222 will couple the velocity so the two entities move in unison. Upon a disturbance to the load, maintain relative position relative to ownship mode 2222 provides thrust in the direction of the disturbance to counteract the disturbance, eliminating the swing.

Move to/stop at position mode 2223: will stabilize an SLCS to a fixed position, counteracting the influence of the weather or small movements of the helicopter or other carrier. This mode has the effect of trying to eliminate all motion. The operator may send a desired target position to the SLCS via the remote interface 2250. This may be accomplished in at least two ways:

Target node position 2224: The operator may place an SLCS remote positional unit or target node or reference 2110 at the desired lowering location. The target node 2110 will communicate wirelessly with the SLCS to indicate the desired position, and the SLCS responds by maneuvering to the desired location. The remote interface 2150 UI, such as UI, may receive and display the location information of both entities.

User-designated position 2225: The operator may use remote interface 2150 UI, such as UI, to send a designated position (e.g., latitude and longitude coordinates) as a commanded location to the SLCS. The system will then steadily direct the suspended load toward the desired position. The system will simultaneously send feedback to the remote interface 2150 UI, such as UI, regarding position and distance information.

Hold Position mode 2226: will resist all motion of an SLCS and maintain current position and/or orientation independent of the ownship's motion. This mode has the effect of eliminating or dampening all motion. This mode has conditional responses respectively to ownship speed, safety factors, and physical constraints.

Direct control mode 2227: Joystick operation of the SLCS in three degrees of freedom. Though operational module 2200 is entirely closed-loop and does not require external control during operation, there may be an option for user control. The operator may be able to directly control positioning, rotation, and thruster output level.

Obstacle avoidance module 2228 module: receives and processes sensor information such as to i) to equalize the distance between sensor locations, such as at fan units and objects, such as obstacles, sensed in the environment or ii) to measure or receive geometry of a load, measure geometry of obstacles sensed in the environment, determine or receive the position, orientation, and motion of the load, and negotiate the load relative to the obstacle.

In block 2230, the operator may complete the operation and retrieves the SLCS apparatus.

In done block 2235, operational module 2200 may be shut down, such as by an interrupt condition, such as by pushing a button on the interactive display or by pressing a button on the center module itself. At done block 2235, operational module 2200 may exit or return to another process.

At block 2240, if the SLCS apparatus includes collapsible propulsion arms or the like, they can be folded up. The load may be detached from a load hook and the SLCS apparatus may be removed from the suspension cable, such as by being detached from a hoist ring at the top of the SLCS. The SLCS may then be stowed in its charger or any convenient location.

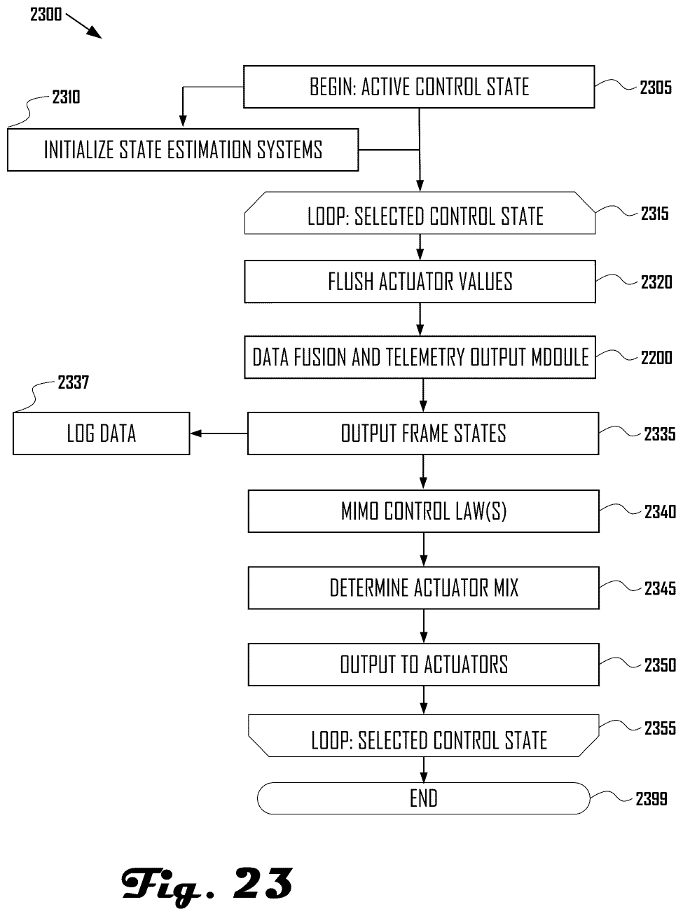

FIG. 23 illustrates decision and control module 2300 of an SLCS in accordance with one embodiment. Instructions of, or which embody, decision and control module 2300 may be stored in, for example, memory 2125, and may be executed or performed by, for example, processor 2120, as well as by electrical circuits, firmware, and other computer and logical hardware of SLCS with which decision and control module 2300 may interact. In embodiments, computer processors and memory to perform some or all of decision and control module 2300 may be remote from SLCS, such as in an auxiliary computer in, for example, a carrier.

Decision and control module 2300 may operate in a closed loop to develop relative and absolute telemetry information, send this data to remote locations, perform a set of calculations to determine the most desired response, then send the desired response to the air propulsion thruster array, for example, to mitigate pendular motion or swing of the cable and suspended load, rotation of the SLCS and suspended load, or otherwise control a suspended load during operations. This process may operate in a continuous loop as long as the system is powered on and a suitable command state is active. This process may operate with data received only from sensors in an SLCS, such as SLCS 105.

In block 2305, an SLCS has been deployed, such as onto a suspension cable, has been activated, and decision and control module 2300 begins active control state, such as upon being powered on, initialized, or otherwise commanded, either by a user or another process, such as operational module 2200. At block 2310, if newly activated, decision and control module 2300 initializes state estimation systems.

Begin loop block 2315 to closing loop block iterate over a command state, such as one selected in block 2220 of operational module 2200.

In block 2320, decision and control module 2300 may flush actuator values, e.g. values sent to actuators, such as EDFs. This may ensure that old values do not contaminate a then-current process loop.

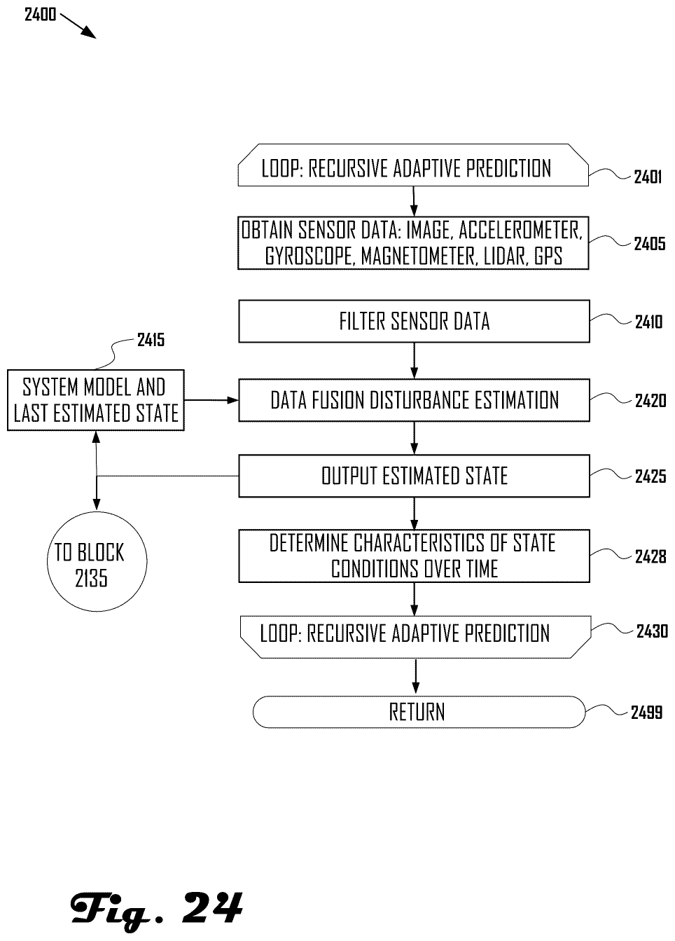

At block 2400, decision and control module 2300 may enter data fusion and telemetry output module 2400, discussed further in relation to FIG. 24. In overview, data fusion and telemetry output module 2400 fuses local motion-based and absolute sensor information to create a deterministic state estimation of state data of the SLCS and carrier coordinate frame. In overview, data fusion and telemetry output module 2400 is updated with most recent values from the sensory suite onboard the SLCS. These values may be obtained in a separate process thread, separate from data fusion and telemetry output module 2400. The measurements are passed to state estimation algorithms, in which data fusion and non-linear state estimation is implemented. Please see, for example, data fusion and telemetry output module 2400.

At block 2335, decision and control module 2300 may output updated frame states, which may be logged at block 2337.

At block 2340, decision and control module 2300 may pass the updated frame states of block 2335 to multi-input multi-output (“MIMO”) control laws. The MIMO control laws may determine an optimal, quantified, correction force based on weighting of severity of current states, and decides how the SLCS should move or exert force to achieve the determined thrust and orientation of the SLCS set by the user-selected functional mode or command state. For example, weighted control laws may include proportional integral derivation (“PID”) with respect to both position and motion. Between the two, severity of motion may dominate relative to position. Control methods weighing cost in terms of energy use may also be considered, as well as additional feedback from past output control to actuators 2350. Output of MIMO control laws may comprise one or more vectors.

At block 2345, determination of actuator mix may be determined, e.g. which EDF to activate and how much. This may be determined according to a matrix which receives vectors from the MIMO control laws and determines corresponding actuator values. Net thrust output is mapped in real-time through encoders and load cells. This determination may first attempt to reduce rotation of a load, such as by generation of a torque force by the SLCS, before attempting to reduce or induce lateral translation of a load.

At block 2350, decision and control module 2300 may output instructions to the actuators to activate them according to the actuator mix determined in block 2345. The result may implement a dynamic response in the form of thrust counteracting unwanted motion or thrust to achieve a desired motion.

In closing loop block 2355, decision and control module 2300 may return to opening loop block to continue iterating over the then-current command state until an exit condition occurs. Exit conditions may include, for example, achieving an objective, such as obtaining or becoming proximate to a location, obtaining a location for a period of time, obtaining a location and receiving an acknowledgment signal, occurrence of an error, or receiving an instruction to exit.

At end block 2399, decision and control module 2300 may exit or return to another process. The process may be unmanned and automated aside from the high-level operator-selected functional control modes. The net output is a force to control or stabilize a suspended load.

FIG. 24 illustrates data fusion and telemetry output module 2400, in accordance with one embodiment. Instructions of, or which embody, data fusion and telemetry output module 2400 may be stored in, for example, memory 2125, and may be executed or performed by, for example, processor 2120, as well as by electrical circuits, firmware, and other computer and logical hardware of SLCS with which data fusion and telemetry output module 2400 may interact. In embodiments, computer processors and memory to perform some or all of data fusion and telemetry output module 2400 may be remote from SLCS, such as in an auxiliary computer in, for example, a carrier.

In data fusion and telemetry output module 2400, local motion-based sensor and absolute position sensor information is fused to create a deterministic state estimation in a coordinate frame of an SLCS and carrier. An example of a data fusion and disturbance estimation algorithm is an Unscented Kalman Filter (“UKF”). The UKF fuses data sources from multiple measurement devices with a nonlinear numerical model to yield a representative state of the coordinate frame of SLCS and carrier. When performed over time, integrals of subsequent representative states may be used to identify rotational and pendular motion, such as rotation of an SLCS about a suspension cable and an oscillation path of an SLCS, such as oscillation path 237.

Kalman filters produce a predicted future state based a past state and a joint probability distribution of a series of measured values in a timespan; the values often contain statistical noise and other inaccuracies. Past values may be discarded and the predicted state then compared to new measured values to produce a new predicted future state. However, Kalman filters may be limited to linear systems. For nonlinear systems, in which non-linearity occurs in either or both the process model or observation model, a Kalman filter may provide poor performance when covariance is propagated through linearization of the underlying non-linear model(s). To address this, an adaptive model may be used, such as an Unscented Kalman Filters (“UKF”), UKF use a deterministic sampling technique, unscented transformation, to pick a minimal set of sample points, which may be referred to as sigma points, around a mean. The sigma points are then propagated through the non-linear functions, from which a new mean and covariance estimate is formed.

An adaptive system model, such as a UKF, may then recursively estimate varying parameters of the then-current system model, including mass of SLCS and load, cable length, inertia of SLCS and load, movement and rotation SLCS, and movement and rotation of the carrier. Inertial based measurements are sent to disturbance estimator matrices of a filter, from which wind force, sea state, and relative SLCS and helicopter motion may be estimated. These state parameters of the adaptive system model may not be “hard-wired” into data fusion and telemetry output module 2400, but may be dynamically determined by data fusion and telemetry output module 2400. For example, when a load comprises only an empty litter weighing thirty-five pounds, the estimated mass of SLCS and load is much less than when the litter is holding a person who weighs two-hundred pounds. The behavior of an SLCS in activating the fans to deal with the dynamic behavior of the lighter load is very different than the behavior of the SLCS to deal with the heavier load and, generally, involves lighter fan actuation. If it did not, and if the SLCS were not able to dynamically determine the mass of the SLCS and load and the other state parameters, the SCLS would not be able to control the lighter load, but may “overdrive” it and make control of the suspended load less likely. If the SLCS were not able to dynamically determine the mass of the SLCS and load, the other state parameters, and the disturbances, the SLCS would not be able to transition from controlling an unweighted litter to controlling a litter containing a person, as occurs during use of an SLCS. Similarly, the estimated length of the cable and/or of inertia has a large effect on pendular motion and how to control it. Systems addressed to control of autonomous vehicles are not known to include system models as described herein, which include continuous and dynamic determination of parameters such as mass of SLCS and load, cable length, inertia of SLCS and load, movement and rotation SLCS, movement and rotation of the carrier, and disturbance estimations of wind force, sea state, and relative SLCS and helicopter motion.

Other closed-loop control methods including fuzzy-tuned proportional, integral, and derivative feedback controllers with bidirectional communication and control methods including deep learning neural nets.

At opening loop block 2401 through closing loop block 2430, data fusion and telemetry output module 2400 estimates a state of a coordinate system based on measured sensor values, iteratively determines a new estimated future state based on new measured values, and performs an integral of successive state values to identify rotation and pendular motion.

At block 2405, data fusion and telemetry output module 2400 obtains sensor data, such as image data, accelerometer, gyroscopic, magnetometer, LIDAR, and, if available, GPS data. Image data may comprise object detection, such as detection of a helicopter or other carrier, as well as components of such an object, such as identification of a cabin and tail. Image data and object detection may also comprise identification of optical flow of such images or pixels in successive frames. Accelerometer data may comprise 3-degree of freedom (“3 DoF”) acceleration data in a sensor coordinate frame. Gyroscope data may comprise 3 DoF angular acceleration data in the sensor coordinate frame. Magnetometer data may comprise 3 Degree of Freedom (“DoF”) magnetic field data in the sensor coordinate frame. LIDAR data may comprise point, sweep, rotating, radial, distance, and/or linear data which measures distance and/or angle relative to objects, the ground, and/or water.

At block 2410, data fusion and telemetry output module 2400 may filter the sensor data, such as to eliminate values which are errors or outside of an allowed range in both time and frequency domains. For example, values not consistent with a sample time range or not consistent with relevant frequencies may be filtered out. For example, suspension cables may be subject to oscillatory and vibratory frequencies; some of such frequencies may be longer than a plausible length of the suspension cable, may be present in sensor data, and may be filtered out.

At block 2415, data fusion and telemetry output module 2400 may feed the system model and its past estimated or initialization state fed to the data fusion disturbance estimate model, such as into a system model in a UKF, to be fused with then-current sensor data. As noted, the UKF and system model may include, and may therefore determine as an estimated state, one or more of a mass of load and SLCS, a cable length, an inertia of load and SLCS, a fan and actuation force of the SLCS, rotational motion of the SLCS, pendular motion of the SLCS, and movement of a carrier and/or of a load over time through an absolute coordinate space.

At block 2420, data fusion and telemetry output module 2400 may determine a new then-current estimated state, based on the system model, last estimated state, and the then-current sensor data. Inertial based measurements are sent to disturbance estimator matrices of a filter, from which wind force, sea state, and relative SLCS and helicopter motion may be estimated.

Estimation of state conditions, such as mass of load and SLCS, cable length, inertia of load and SLCS, fan and actuation forces of the SLCS, rotational motion of the SLCS, pendular motion of the SLCS, and movement of a carrier and/or load over time through an absolute coordinate space and disturbance estimations, such as wind force, sea state, and relative SLCS and helicopter motion are not know to be practiced by previous control systems for unmanned vehicles.

At block 2425, data fusion and telemetry output module 2400 may output the then-current estimated state. This may be output to, for example, a record accessed by block 2335 of decision and control module 2300 and/or to a record accessed by block 2415 to be fed into the next iteration, if any, of the data fusion disturbance estimate model.

At block 2428, data fusion and telemetry output module 2400 may determine characteristics of state conditions over time, such as rotation or pendular motion of SLCS, movement of a carrier over time through an absolute coordinate space, and the like. Such characteristics may be determined by determining integrals of such state conditions over time.

At closing loop block 2430, data fusion and telemetry output module 2400 may return to opening loop block 2401, unless or until an exit condition occurs.

At end block 2499, data fusion and telemetry output module 2400 may exit or return to another process.

FIG. 25 schematically illustrates electronic computer, hardware, and network connections among operational components 2500 of a suspended load control system, according with one embodiment. Operational components 2500 may be understood as implementing SLCS logical components 2101.

Embedded computer 2505 may be a computer processor or central processing unit (CPU). The processor may be an embedded system including a signal board computer and one or more microcontroller units (“MCUs”). The CPU and MCUs may be contained within a housing in which data link and electrical connections may be made, such as connections 2560 through 2594. Embedded computer 2505 may comprise computer memory, such as SLCS memory 2125.

Connection 2570, which may be a serial data connection, may connect embedded computer 2505 with inertial navigation system 2510. Inertial navigation system 2510 may comprise the IMS and GPS, discussed herein.

Connection 2575, which may be a gigabit ethernet data connection, may connect embedded computer 2505 with one or more optical sensors 2555, such as visible light, IR, and other cameras, as discussed herein.

Connection 2580, which may be a UDP over gigabit ethernet data connection, may connect embedded computer 2505 with one or more LIDAR 2550 systems, as discussed herein.

Connection 2585, which may be a general purpose, input-output connection, may connect embedded computer 2505 with one or more DC contactors, peripherals 2545, and the like.

Connection 2590, which may be a pulse width modulated electrical connection, may connect embedded computer 2505 with one or more LED status indicators 2540.

Connection 2594, which may be WiFi or wired ethernet UDP/TCP data connection, may connect embedded computer 2505 with one or more user control devices 2535, such as interactive display or remote interface 2150.

Connection 2596, which may be an HDMI data connection, may connect embedded computer 2505 with one or more HDMI output display devices 2530.

Connection 2560, which may be a USB data and electrical connection, may connect embedded computer 2505 with one or more USB devices 2525.

Connections 2565, which may form a CAN data bus, may connect embedded computer 2505 with one or more electronic speed controllers 2515 and one or more sensory feedback units 2520. ESC 2515 may be a thruster controller to allow embedded computer 2505 to control the speed, power draw, and thrust of thrusters in the EDF. An ESC may have the following connections: to the power supply, to a thruster, and to the processor, such as embedded computer 2505, to a microcontroller, and/or to sensory feedback units 2520. ESC pulls power from the power supply and allocates it to the thrusters to control the amount of thrust produced by EDF.

A remote interface or remote pendant may comprise, for example, an on/off switch, state selector, and manual/rotational control. The on/off switch may be used to turn on the remote pendant. The state selector may be used to select a command state of operational module 2200, as may be discussed in relation to FIG. 22. An activation controller may be used to activate or deactivate an SLCS in or relative to a selected command state. The manual/rotational control may be used to manually activate fans to rotate or translate a load when, for example, the state selector has been used to select, for example, direct control mode 2227. A joystick may be incorporated into the remote pendant, such as in replacement of or in addition to the manual control.

Although specific embodiments have been illustrated and described herein, it will be appreciated by those of ordinary skill in the art that alternate and/or equivalent implementations may be substituted for the specific embodiments shown and described without departing from the scope of the present disclosure. For example, although various embodiments are described above in terms of a helicopter ownship, in other embodiments an SLCS may be employed under a construction crane or gantry. This application is intended to cover any adaptations or variations of the embodiments discussed herein.

Following are non-limiting examples:

Example 1. An apparatus for a load control system to control a load suspended from a carrier, comprising: a computer processor and a memory; a sensor suite to obtain a sensor data regarding a position and orientation of the load control system and/or load; a data fusion module in the memory to determine an estimated state of the load control system and/or load based on the sensor data; a fan array; and a decision and control module in the memory to control the fan array to output at least one of a lateral force or torque on the load control system and/or load based on the estimated state of the load control system and/or load to control the load suspended from the carrier; wherein the load control system, including the sensor suite, are configured to be located proximate to the load at a bottom of a suspension cable spanning between the load and the carrier.

Example 2. The apparatus according to example 1, wherein the load control system and load are subject to an external force, wherein the external force is from at least one of movement of the load by the carrier, an environmental wind, or a wind generated by the carrier and wherein the external force causes or contributes to an undesired movement of the load control system and the load, and wherein to control the load suspended from the carrier is to counteract the undesired movement of the load.

Example 3. The apparatus according to example 1, wherein to determine the estimated state of the load control system and/or load based on the sensor data comprises recursively predicting the estimated state based on a last previously estimated state, the sensor data, a system model, and an estimate of uncertainty of the estimated state.

Example 4. The apparatus according to example 3, wherein recursively predicting the estimated physical state based on a last previously estimated physical state, the sensor data, the system model, and the estimate of uncertainty of the estimated physical state comprises processing the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 5. The apparatus according to example 3, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 6. The apparatus according to example 1, wherein to control the fan array to output at least one of the lateral force or torque on the load control system and/or load based on the estimated state of the load control system and/or load to control the load suspended from the carrier comprises to output frame states for the estimated state of the load control system and/or load, translate the frame states into multi-input multi-output (“MIMO”) control laws, determine an actuator matrix for the fan array, and output the MIMO control laws to the fan array according to the actuator matrix.

Example 7. A computer implemented method to control a load suspended from a carrier, comprising: with a computer processor and memory, obtaining a sensor data from a sensor suite regarding a position and orientation of the load; determining an estimated state of the load based on the sensor data; controlling a fan array to output at least one of a lateral force or torque on the load based on the estimated state of the load to control the load suspended from the carrier; wherein the computer processor and memory and the sensor suite are configured to be located proximate to the load at a bottom of a suspension cable spanning between the load and the carrier.

Example 8. The computer implemented method according to example 7, wherein the load is subject to an external force, wherein the external force is from at least one of movement of the load by the carrier, an environmental wind, or a wind generated by the carrier and wherein the external force causes or contributes to an undesired movement of the load, and wherein to control the load suspended from the carrier is to counteract the undesired movement of the load control system and the load.

Example 9. The computer implemented method according to example 7, wherein determining the estimated state of the load control system and/or load based on the sensor data comprises recursively predicting the estimated state based on a last previously estimated state, the sensor data, a system model, and an estimate of uncertainty of the estimated state.

Example 10. The computer implemented method according to example 9, wherein recursively predicting the estimated physical state based on a last previously estimated physical state, the sensor data, the system model, and the estimate of uncertainty of the estimated physical state comprises processing the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 11. The computer implemented method according to example 9, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 12. The computer implemented method according to example 7, wherein controlling the fan array to output at least one of the lateral force or torque on the load based on the estimated state of the load to control the load suspended from the carrier comprises outputting frame states for the estimated state of the load control system and/or load, translating the frame states into multi-input multi-output (“MIMO”) control laws, determining an actuator matrix for the fan array, and outputting the MIMO control laws to the fan array according to the actuator matrix.

Example 13. A computer apparatus to control a load suspended from a carrier, comprising: means to obtain a sensor data from a sensor suite regarding a position and orientation of the load; means to determine an estimated state of the load based on the sensor data; means to control a fan array to output at least one of a lateral force or torque on the load based on the estimated state of the load to control the load suspended from the carrier; wherein the means to obtain the sensor data, the means to determine the estimated state of the load, and means to control the fan array are configured to be located proximate to the load at a bottom of a suspension cable spanning between the load and the carrier.

Example 14. The computer apparatus according to example 13, wherein the load is subject to an external force, wherein the external force is from at least one of movement of the load by the carrier, an environmental wind, or a wind generated by the carrier and wherein the external force causes or contributes to an undesired movement of the load, and wherein to control the load suspended from the carrier is to counteract the undesired movement of the load.

Example 15. The computer apparatus according to example 13, wherein the means to determine the estimated state of the load control system and/or load based on the sensor data comprises means to recursively predict the estimated state based on a last previously estimated state, the sensor data, a system model, and an estimate of uncertainty of the estimated state.

Example 16. The computer apparatus according to example 15, wherein means to recursively predict the estimated physical state based on a last previously estimated physical state, the sensor data, the system model, and the estimate of uncertainty of the estimated physical state comprises means to process the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 17. The computer apparatus according to example 15, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 18. The computer apparatus according to example 13, wherein the means to control the fan array to output at least one of the lateral force or torque on the load based on the estimated state of the load to control the load suspended from the carrier comprises means to output frame states for the estimated state of the load control system and/or load, translate the frame states into multi-input multi-output (“MIMO”) control laws, determine an actuator matrix for the fan array, and output the MIMO control laws to the fan array according to the actuator matrix.

Example 19. One or more computer-readable media comprising instructions that cause a computer device, in response to execution of the instructions by a processor of the computer device, to: obtain a sensor data from a sensor suite regarding a position and orientation of the load; determine an estimated state of the load based on the sensor data; control a fan array to output at least one of a lateral force or torque on the load based on the estimated state of the load to control the load suspended from the carrier; wherein the computer device is located proximate to the load at a bottom of a suspension cable spanning between the load and the carrier.

Example 20. The computer-readable media comprising instructions according to example 19, wherein the load is subject to an external force, wherein the external force is from at least one of movement of the load by the carrier, an environmental wind, or a wind generated by the carrier and wherein the external force causes or contributes to an undesired movement of the load, and wherein to control the load suspended from the carrier is to counteract the undesired movement of the load.

Example 21. The computer-readable media comprising instructions according to example 19, wherein to determine the estimated state of the load control system and/or load based on the sensor data comprises to recursively predict the estimated state based on a last previously estimated state, the sensor data, a system model, and an estimate of uncertainty of the estimated state.

Example 22. The computer-readable media comprising instructions according to example 21, wherein to recursively predict the estimated physical state based on a last previously estimated physical state, the sensor data, the system model, and the estimate of uncertainty of the estimated physical state comprises to process the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 23. The computer-readable media comprising instructions according to example 21, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 24. The computer-readable media comprising instructions according to example 19, wherein to control the fan array to output at least one of the lateral force or torque on the load based on the estimated state of the load to control the load suspended from the carrier comprises to output frame states for the estimated state of the load control system and/or load, translate the frame states into multi-input multi-output (“MIMO”) control laws, determine an actuator matrix for the fan array, and output the MIMO control laws to the fan array according to the actuator matrix.

Example 25. A thruster positioning mechanism to releasably secure at least a first thruster in a plurality of thrusters of a suspended load control apparatus, the thruster positioning mechanism comprising: a thruster prismatic joint and a thruster releasable body, wherein the thruster prismatic joint is to provide the first thruster at least a one degree of freedom of thruster translation in the suspended load control apparatus and the thruster releasable body is to releasably preclude motion of the first thruster in the one degree of freedom of thruster translation provided by the thruster prismatic joint, and wherein the suspended load control apparatus is to control a load suspended on a suspension cable below a carrier.

Example 26. The thruster positioning mechanism according to Example 25 or another claim or example herein, wherein the thruster prismatic joint comprises the first thruster and a beam.

Example 27. The thruster positioning mechanism according to any one or more of Example 25 to Example 26 or another claim or example herein, wherein the thruster prismatic joint comprises a first thruster structure, a beam structure, wherein the first thruster structure and the beam structure interlock and limit translation of the first thruster at least to the one degree of freedom of thruster translation, and wherein the thruster releasable body is releasably securable to the first thruster and across the beam structure and, when so secured, releasably precludes motion of the first thruster in the one degree of freedom of thruster translation by releasably preventing shear force on the first thruster from translating the first thruster in the one degree of freedom of thruster translation.

Example 28. The thruster positioning mechanism according to any one or more of Example 25 to Example 27 or another claim or example herein, wherein the first thruster structure comprises a protrusion and the beam structure comprises a beam groove corresponding to the protrusion and wherein the protrusion and the beam groove interlock and limit translation of the first thruster at least to the one degree of freedom of thruster translation in the suspended load control apparatus.

Example 29. The thruster positioning mechanism according to any one or more of Example 25 to Example 27 or another claim or example herein, wherein the thruster releasable body comprises a bushing.

Example 30. The thruster positioning mechanism according to any one or more of Example 25 to Example 29 or another claim or example herein, wherein the bushing is releasably securable to the first thruster, and when so secured, releasably precludes motion of the first thruster in the one degree of freedom of thruster translation by releasably preventing shear force on the first thruster from translating the first thruster in the one degree of freedom of thruster translation.

Example 31. The thruster positioning mechanism according to any one or more of Example 25 to Example 30 or another claim or example herein, wherein a bolt is to releasably secure the bushing to the first thruster and generate a compressive force on and a friction between the bushing, the beam, and the first thruster, and wherein the compressive force and the friction is to preclude motion of the first thruster in the one degree of freedom of thruster translation and releasably prevent shear force on the first thruster from translating the first thruster in the one degree of freedom of thruster translation.

Example 32. The thruster positioning mechanism according to any one or more of Example 25 to Example 26 or another claim or example herein, wherein beam is a first beam, further comprising a second beam, and wherein the thruster prismatic joint comprises the first thruster, the first beam, and the second beam.

Example 33. The thruster positioning mechanism according to any one or more of Example 25 to Example 32 or another claim or example herein, wherein the thruster prismatic joint comprises the first thruster interposed between the first beam and the second beam.

Example 34. The thruster positioning mechanism according to any one or more of Example 25 to Example 32 or another claim or example herein, wherein the thruster positioning mechanism further comprises a second thruster releasable body and wherein the thruster prismatic joint further comprises the first thruster releasably secured to the first beam by the thruster releasable body and the first thruster releasably secured to the second beam by the second thruster releasable body.

Example 35. The thruster positioning mechanism according to any one or more of Example 25 to Example 29 or another claim or example herein, wherein the thruster positioning mechanism further comprises a suspended load control apparatus or system (“SLCS”) securement mechanism, wherein the SLCS securement mechanism comprises a clasp, wherein the clasp is releasably securable to the bushing and wherein the clasp is to releasably secure the suspended load control apparatus to the load.

Example 36. The thruster positioning mechanism according to any one or more of Example 25 to Example 35 or another claim or example herein, wherein the clasp comprises a clasp base plate and wherein clasp base plate is to be releasably secured to the bushing.

Example 37. The thruster positioning mechanism according to any one or more of Example 25 to Example 36 or another claim or example herein, further comprising a clasp prismatic joint, wherein the clasp prismatic joint is to provide the clasp at least a one degree of freedom of clasp translation relative to the suspended load control apparatus.

Example 38. The thruster positioning mechanism according to any one or more of Example 25 to Example 37 or another claim or example herein, wherein the one degree of freedom of thruster translation and the one degree of freedom of clasp translation are perpendicular to one another.

Example 39. The thruster positioning mechanism according to any one or more of Example 25 to Example 37 or another claim or example herein, wherein the clasp prismatic joint comprises a bushing groove in the bushing and the clasp, wherein the clasp is releasably securable to the bushing grove by a flange.

Example 40. The thruster positioning mechanism according to any one or more of Example 25 to Example 39 or another claim or example herein, further comprising a clasp releasable body, wherein the clasp releasable body comprises the clasp releasably secured to the flange and in the bushing grove and, when secured, is to releasably preclude motion of the clasp in the one degree of freedom of clasp translation provided by the clasp prismatic joint.

Example 41. The thruster positioning mechanism according to any one or more of Example 25 to Example 39 or another claim or example herein, wherein beam groove and the bushing groove are perpendicular to one another.

Example 42. The thruster positioning mechanism according to any one or more of Example 25 to Example 29 or another claim or example herein, wherein the clasp is a first clasp, wherein the thruster positioning mechanism further comprises a second clasp.

Example 43. The thruster positioning mechanism according to any one or more of Example 25 to Example 42 or another claim or example herein, wherein the bushing is first bushing and further comprising a second bushing, wherein the first clasp comprises a first clasp base plate and wherein first clasp base plate is releasably securable to the first bushing and wherein the first beam is between the first clasp base plate, the first bushing, and the first thruster and wherein the second clasp comprises a second clasp base plate and wherein the second clasp base plate is releasably securable to the second bushing by the second bolt and wherein the second beam is between the second clasp base plate, the second bushing, and the first thruster.

Example 44. The thruster positioning mechanism according to any one or more of Example 25 to Example 26 or another claim or example herein, wherein the beam comprises at least one of a plate, an I-beam, or a tube, wherein the tube has a cross section comprising at least one of an ellipse and a rectangle.

Example 45. The thruster positioning mechanism according to any one or more of Example 25 to Example 25 or another claim or example herein, wherein the thruster comprises a thruster housing and, within the thruster housing, at least one ducted fan.

Example 46. The thruster positioning mechanism according to any one or more of Example 25 to Example 45 or another claim or example herein, wherein the at least one ducted fan comprises a first ducted fan and a second ducted fan.

Example 47. The thruster positioning mechanism according to any one or more of Example 25 to Example 46 or another claim or example herein, wherein the load comprises a rescue litter.

Example 48. The thruster positioning mechanism according to any one or more of Example 25 to Example 25 or another claim or example herein, wherein the suspended load control apparatus further comprises a computer processor and a memory; a sensor suite to obtain a sensor data regarding a position and orientation of the load control system and/or load; a data fusion module in the memory to determine an estimated state of the load control system and/or load based on the sensor data; a fan array comprising the first fan; and a decision and control module in the memory to control the fan array to output at least one of a lateral force or torque on the load control system and/or load based on the estimated state of the load control system and/or load to control the load suspended from the carrier; wherein the load control system, including the sensor suite, are configured to be located proximate to the load at a bottom of a suspension cable spanning between the load and the carrier.

Example 49. The thruster positioning mechanism according to any one or more of Example 25 to Example 48 or another claim or example herein, wherein the load control system and load are subject to an external force, wherein the external force is from at least one of movement of the load by the carrier, an environmental wind, or a wind generated by the carrier and wherein the external force causes or contributes to an undesired movement of the load control system and the load, and wherein to control the load suspended from the carrier is to counteract the undesired movement of the load.

Example 50. The thruster positioning mechanism according to any one or more of Example 25 to Example 48 or another claim or example herein, wherein to determine the estimated state of the load control system and/or load based on the sensor data comprises recursively predicting the estimated state based on a last previously estimated state, the sensor data, a system model, and an estimate of uncertainty of the estimated state.

Example 51. The thruster positioning mechanism according to any one or more of Example 25 to Example 50 or another claim or example herein, wherein recursively predicting the estimated physical state based on a last previously estimated physical state, the sensor data, the system model, and the estimate of uncertainty of the estimated physical state comprises processing the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 52. The thruster positioning mechanism according to any one or more of Example 25 to Example 51 or another claim or example herein, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 53. The thruster positioning mechanism according to any one or more of Example 25 to Example 52 or another claim or example herein, wherein recursively predicting the estimated physical state based on a last previously estimated physical state, the sensor data, the system model, and the estimate of uncertainty of the estimated physical state comprises predicting at a location and motion in relative and absolute coordinate frames of at least one of the load, the load control system, or the carrier.

Example 54. The thruster positioning mechanism according to any one or more of Example 25 to Example 53 or another claim or example herein, wherein to control the fan array to output at least one of the lateral force or torque on the load control system and/or load based on the estimated state of the load control system and/or load to control the load suspended from the carrier comprises to output frame states for the estimated state of the load control system and/or load, translate the frame states into multi-input multi-output (“MIMO”) control laws, determine an actuator matrix for the fan array, and output the MIMO control laws to the fan array according to the actuator matrix.

Example 55. A suspended load control apparatus or system (“SLCS”) securement mechanism to releasably secure a suspended load control apparatus to a load, the SLCS securement mechanism comprising: a clasp prismatic joint, a clasp releasable body, wherein the clasp releasable body comprises a clasp, wherein the clasp is to releasably secure the suspended load control apparatus to the load, wherein the clasp prismatic joint is to provide the clasp at least a one degree of freedom of clasp translation in the suspended load control apparatus, wherein the clasp releasable body is to releasably preclude motion of the clasp in the one degree of freedom of clasp translation provided by the clasp prismatic joint, and wherein the suspended load control apparatus is to control the load suspended below the carrier on a suspension cable.

Example 56. The SLCS securement mechanism according to any one or more of Example 25 to Example 55 or another claim or example herein, wherein the clasp prismatic joint comprises a bushing groove in a bushing and a flange, wherein the flange fits within the bushing groove, the flange is to releasably secure the clasp in the flange, and the bushing groove and the flange together provide the one degree of freedom of clasp translation.

Example 57. The SLCS securement mechanism according to any one or more of Example 25 to Example 56 or another claim or example herein, wherein the clasp releasable body comprises a clasp base plate bolt releasably secured to the flange, and the clasp base plate bolt and the flange are to releasably secure the clasp to the suspended load control apparatus and releasably preclude motion of the clasp in the one degree of freedom of clasp translation provided by the clasp prismatic joint.

Example 58. The SLCS securement mechanism according to any one or more of Example 25 to Example 57 or another claim or example herein, wherein the clasp base plate bolt is to releasably secure the clasp to the flange and generate a compressive force on and a friction between the clasp and the flange, and wherein the compressive force and the friction are to preclude motion of the clasp in the one degree of freedom of clasp translation and releasably prevent shear force on the clasp from translating the clasp in the one degree of freedom of clasp translation.

Example 59. The SLCS securement mechanism according to any one or more of Example 25 to Example 56 or another claim or example herein, wherein the clasp releasable body comprises a clasp-position retaining pin, wherein the clasp-position retaining pin is to releasably engage with a hole of or secured to the SLCS and releasably prevent shear force on the clasp from translating the clasp in the one degree of freedom of clasp translation.

Example 60. The SLCS securement mechanism according to any one or more of Example 25 to Example 59 or another claim or example herein, wherein the clasp-position retaining pin is spring loaded.

Example 61. The SLCS securement mechanism according to any one or more of Example 25 to Example 59 or another claim or example herein, wherein the hole of or secured to the suspended load control apparatus is a hole in a bushing.

Example 62. The SLCS securement mechanism according to any one or more of Example 25 to Example 61 or another claim or example herein, wherein the bushing is between the clasp and the suspended load control apparatus.

Example 63. The SLCS securement mechanism according to any one or more of Example 25 to Example 61 or another claim or example herein, wherein the hole of or secured to the suspended load control apparatus is a first hole of or secured to the suspended load control apparatus, and further comprising a second hole of or secured to the suspended load control apparatus, wherein the first hole of or secured to the suspended load control apparatus and the second hole of or secured to the suspended load control apparatus are spaced to allow the clasp to be secured to a range of structures on the load.

Example 64. The SLCS securement mechanism according to any one or more of Example 25 to Example 55 or another claim or example herein, wherein the SLCS securement mechanism further comprises a first thruster and a thruster positioning mechanism, wherein the thruster positioning mechanism comprises a thruster prismatic joint, wherein the thruster positioning mechanism and thruster prismatic joint are to provide the first thruster at least a one degree of freedom of thruster translation in the suspended load control apparatus.

Example 65. The SLCS securement mechanism according to any one or more of Example 25 to Example 64 or another claim or example herein, further comprising a beam, wherein the bushing is releasably securable to the first thruster, wherein the bushing and the beam are between the clasp and the first thruster.

Example 66. The SLCS securement mechanism according to any one or more of Example 25 to Example 65 or another claim or example herein, wherein the clasp comprises a clasp base plate and wherein clasp base plate is to be releasably secured to the bushing.

Example 67. The SLCS securement mechanism according to any one or more of Example 25 to Example 66 or another claim or example herein, wherein a bolt is to releasably secure the clasp base plate to the bushing.

Example 68. The SLCS securement mechanism according to any one or more of Example 25 to Example 58 or another claim or example herein, wherein the clasp comprises a clasp finger and a clasp finger engagement assembly, wherein the clasp finger engagement assembly is to releasably secure the clasp and the suspended load control apparatus to the load.

Example 69. The SLCS securement mechanism according to any one or more of Example 25 to Example 68 or another claim or example herein, wherein the clasp finger is a first clasp finger, further comprising a second clasp finger and wherein the clasp finger engagement assembly comprises a clasp cam, wherein the clasp cam is to releasably reduce a distance between the first clasp finger and the second clasp finger, and a clasp release spring, wherein the clasp release spring is to increase the distance between the first clasp finger and the second clasp finger when the clasp cam is disengaged.

Example 70. The SLCS securement mechanism according to any one or more of Example 25 to Example 69 or another claim or example herein, wherein the clasp further comprises a clasp pivot rod, wherein the clasp pivot rod is to allow at least the first clasp finger to rotate about the clasp pivot rod between at least a first clasp posture and a second clasp posture.

Example 71. The SLCS securement mechanism according to any one or more of Example 25 to Example 70 or another claim or example herein, wherein the first clasp posture is to secure the clasp to the load and the second clasp posture is to reduce a volume of space occupied by the clasp.

Example 72. The SLCS securement mechanism according to any one or more of Example 25 to Example 71 or another claim or example herein, wherein the clasp further comprises a cam retaining trigger, wherein the cam retaining trigger is to releasably retain the clasp cam when the clasp cam is engaged relative to the first clasp finger and the second clasp finger.

Example 73. The SLCS securement mechanism according to any one or more of Example 25 to Example 55 or another claim or example herein, wherein the load comprises a rescue litter.

Example 74. The SLCS securement mechanism according to any one or more of Example 25 to Example 55 or another claim or example herein, wherein the suspended load control apparatus further comprises a computer processor and a memory; a sensor suite to obtain a sensor data regarding a position and orientation of the load control system and/or load; a data fusion module in the memory to determine an estimated state of the load control system and/or load based on the sensor data; a fan array comprising a first fan; and a decision and control module in the memory to control the fan array to output at least one of a lateral force or torque on the load control system and/or load based on the estimated state of the load control system and/or load to control the load suspended from the carrier; wherein the load control system, including the sensor suite, are configured to be located proximate to the load at a bottom of a suspension cable spanning between the load and the carrier.

Example 75. The SLCS securement mechanism according to any one or more of Example 25 to Example 74 or another claim or example herein, wherein the load control system and load are subject to an external force, wherein the external force is from at least one of movement of the load by the carrier, an environmental wind, or a wind generated by the carrier and wherein the external force causes or contributes to an undesired movement of the load control system and the load, and wherein to control the load suspended from the carrier is to counteract the undesired movement of the load.

Example 76. The SLCS securement mechanism according to any one or more of Example 25 to Example 75 or another claim or example herein, wherein to determine the estimated state of the load control system and/or load based on the sensor data comprises recursively predicting the estimated state based on a last previously estimated state, the sensor data, a system model, and an estimate of uncertainty of the estimated state.

Example 77. The SLCS securement mechanism according to any one or more of Example 25 to Example 76 or another claim or example herein, wherein recursively predicting the estimated physical state based on a last previously estimated physical state, the sensor data, the system model, and the estimate of uncertainty of the estimated physical state comprises processing the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 78. The SLCS securement mechanism according to any one or more of Example 25 to Example 77 or another claim or example herein, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 79. The SLCS securement mechanism according to any one or more of Example 25 to Example 78 or another claim or example herein, wherein recursively predicting the estimated physical state based on a last previously estimated physical state, the sensor data, the system model, and the estimate of uncertainty of the estimated physical state comprises predicting at a location and motion in relative and absolute coordinate frames of at least one of the load, the load control system, or the carrier.

Example 80. The SLCS securement mechanism according to any one or more of Example 25 to Example 79 or another claim or example herein, wherein to control the fan array to output at least one of the lateral force or torque on the load control system and/or load based on the estimated state of the load control system and/or load to control the load suspended from the carrier comprises to output frame states for the estimated state of the load control system and/or load, translate the frame states into multi-input multi-output (“MIMO”) control laws, determine an actuator matrix for the fan array, and output the MIMO control laws to the fan array according to the actuator matrix.

Example 81. The apparatus according to any one or more of Example 25 to Example 55 or another claim or example herein, wherein the one degree of freedom of clasp translation is to accommodate irregularities in at least one dimension of the load.

Example 82. A method to position at least a first thruster in a plurality of thrusters of a suspended load control apparatus, the method comprising: positioning the thruster with a thruster prismatic joint, wherein the thruster prismatic joint provides the first thruster at least a one degree of freedom of thruster translation in the suspended load control apparatus and releasably precluding motion of the first thruster in the one degree of freedom of thruster translation provided by the thruster prismatic joint with a thruster releasable body, and wherein the suspended load control apparatus is to control a load suspended on a suspension cable below a carrier.

Example 83. The method according to Example 82 or another claim or example herein, wherein the thruster prismatic joint comprises the first thruster and a beam.

Example 84. The method according to any one or more of Example 82 to Example 83 or another claim or example herein, wherein the thruster prismatic joint comprises a first thruster structure, a beam structure, and further comprising interlocking the first thruster structure and the beam structure to and limit translation of the first thruster at least to the one degree of freedom of thruster translation, and further comprising releasably securing the thruster releasable body to the first thruster and across the beam structure to thereby releasably preclude motion of the first thruster in the one degree of freedom of thruster translation by releasably preventing shear force on the first thruster from translating the first thruster in the one degree of freedom of thruster translation.

Example 85. The method according to any one or more of Example 82 to Example 84 or another claim or example herein, wherein the first thruster structure comprises a protrusion and the beam structure comprises a beam groove corresponding to the protrusion and further comprising interlocking the protrusion and the beam groove and thereby limiting translation of the first thruster at least to the one degree of freedom of thruster translation in the suspended load control apparatus.

Example 86. The method according to any one or more of Example 82 to Example 84 or another claim or example herein, wherein the thruster releasable body comprises a bushing.

Example 87. The method according to any one or more of Example 82 to Example 86 or another claim or example herein, further comprising releasably securing the bushing to the first thruster, and thereby releasably precluding motion of the first thruster in the one degree of freedom of thruster translation by releasably preventing shear force on the first thruster from translating the first thruster in the one degree of freedom of thruster translation.

Example 88. The method according to any one or more of Example 82 to Example 87 or another claim or example herein, further comprising releasably securing the bushing to the first thruster with a bolt and thereby generating a compressive force on and a friction between the bushing, the beam, and the first thruster, wherein the compressive force and the friction is to preclude motion of the first thruster in the one degree of freedom of thruster translation and releasably prevent shear force on the first thruster from translating the first thruster in the one degree of freedom of thruster translation.

Example 89. The method according to any one or more of Example 82 to Example 83 or another claim or example herein, wherein beam is a first beam, further comprising a second beam, and wherein the thruster prismatic joint comprises the first thruster, the first beam, and the second beam.

Example 90. The method according to any one or more of Example 82 to Example 89 or another claim or example herein, wherein the thruster prismatic joint comprises the first thruster interposed between the first beam and the second beam.

Example 91. The method according to any one or more of Example 82 to Example 89 or another claim or example herein, wherein the thruster releasable body is a first thruster releasable body and further comprising a second thruster releasable body and, with the thruster prismatic joint, further releasably securing the first thruster to the first beam with the first thruster releasable body and releasably securing the first thruster to the second beam with the second thruster releasable body.

Example 92. The method according to any one or more of Example 82 to Example 86 or another claim or example herein, further comprising a suspended load control apparatus or system (“SLCS”) securement mechanism, wherein the SLCS securement mechanism comprises a clasp, wherein the clasp is releasably securable to the bushing and further comprising releasably securing the SCLS to the load with SLCS securement mechanism comprising the clasp.

Example 93. The method according to any one or more of Example 82 to Example 92 or another claim or example herein, wherein the clasp comprises a clasp base plate and further comprising securing the clasp base plate to the bushing.

Example 94. The method according to any one or more of Example 82 to Example 93 or another claim or example herein, further comprising providing the clasp at least a one degree of freedom of clasp translation relative to the suspended load control apparatus with a clasp prismatic joint.

Example 95. The method according to any one or more of Example 82 to Example 94 or another claim or example herein, wherein the one degree of freedom of thruster translation and the one degree of freedom of clasp translation are perpendicular to one another.

Example 96. The method according to any one or more of Example 82 to Example 94 or another claim or example herein, wherein the clasp prismatic joint comprises a bushing groove in the bushing and the clasp, and further comprising releasably securing the clasp to the bushing grove with a flange.

Example 97. The method according to any one or more of Example 82 to Example 96 or another claim or example herein, further comprising a clasp releasable body, further comprising releasably securing the clasp releasable body to the flange and in the bushing grove and thereby releasably precluding motion of the clasp in the one degree of freedom of clasp translation provided by the clasp prismatic joint.

Example 98. The method according to any one or more of Example 82 to Example 96 or another claim or example herein, wherein beam groove and the bushing groove are perpendicular to one another.

Example 99. The method according to any one or more of Example 82 to Example 96 or another claim or example herein, wherein the clasp is a first clasp and further comprising a second clasp.

Example 100. The method according to any one or more of Example 82 to Example 99 or another claim or example herein, wherein the bushing is first bushing and further comprising a second bushing, wherein the first clasp comprises a first clasp base plate and further comprising releasably securing the first clasp base plate to the first bushing with the first beam between the first clasp base plate, the first bushing, and the first thruster and wherein the second clasp comprises a second clasp base plate and further comprising releasably securing the second clasp base plate to the second bushing with the second bolt with the second beam is between the second clasp base plate, the second bushing, and the first thruster.

Example 101. The method according to any one or more of Example 82 to Example 83 or another claim or example herein, wherein the beam comprises at least one of a plate, an I-beam, or a tube, wherein the tube has a cross section comprising at least one of an ellipse and a rectangle.

Example 102. The method according to Example 82 or another claim or example herein, wherein the thruster comprises a thruster housing and, within the thruster housing, at least one ducted fan.

Example 103. The method according to any one or more of Example 82 to Example 102 or another claim or example herein, wherein the at least one ducted fan comprises a first ducted fan and a second ducted fan.

Example 104. The method according to any one or more of Example 82 to Example 103 or another claim or example herein, wherein the load comprises a rescue litter.

Example 105. The method according to any one or more of Example 82 to Example 82 or another claim or example herein, wherein the suspended load control apparatus further comprises a computer processor and a memory; a sensor suite to obtain a sensor data regarding a position and orientation of the load control system and/or load; a data fusion module in the memory to determine an estimated state of the load control system and/or load based on the sensor data; a fan array comprising the first fan; and a decision and control module in the memory and further comprising controlling the fan array with the decision and control module to output at least one of a lateral force or torque on the load control system and/or load based on the estimated state of the load control system and/or load to control the load suspended from the carrier; wherein the load control system, including the sensor suite, are configured to be located proximate to the load at a bottom of a suspension cable spanning between the load and the carrier.

Example 106. The method according to any one or more of Example 82 to Example 105 or another claim or example herein, wherein the load control system and load are subject to an external force, wherein the external force is from at least one of movement of the load by the carrier, an environmental wind, or a wind generated by the carrier and wherein the external force causes or contributes to an undesired movement of the load control system and the load, and further comprising controlling the load suspended from the carrier to counteract the undesired movement of the load.

Example 107. The method according to any one or more of Example 82 to Example 105 or another claim or example herein, wherein to determine the estimated state of the load control system and/or load based on the sensor data comprises recursively predicting the estimated state based on a last previously estimated state, the sensor data, a system model, and an estimate of uncertainty of the estimated state.

Example 108. The method according to any one or more of Example 82 to Example 107 or another claim or example herein, wherein recursively predicting the estimated physical state based on a last previously estimated physical state, the sensor data, the system model, and the estimate of uncertainty of the estimated physical state comprises processing the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 109. The method according to any one or more of Example 82 to Example 108 or another claim or example herein, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 110. The method according to any one or more of Example 82 to Example 109 or another claim or example herein, wherein recursively predicting the estimated physical state based on a last previously estimated physical state, the sensor data, the system model, and the estimate of uncertainty of the estimated physical state comprises predicting at a location and motion in relative and absolute coordinate frames of at least one of the load, the load control system, or the carrier.

Example 111. The method according to any one or more of Example 82 to Example 110 or another claim or example herein, wherein to control the fan array to output at least one of the lateral force or torque on the load control system and/or load based on the estimated state of the load control system and/or load to control the load suspended from the carrier comprises to output frame states for the estimated state of the load control system and/or load, translate the frame states into multi-input multi-output (“MIMO”) control laws, determine an actuator matrix for the fan array, and output the MIMO control laws to the fan array according to the actuator matrix.

Example 112. A method to releasably secure a suspended load control apparatus (“SLCS”) to a load, the method comprising: with a clasp prismatic joint and a clasp releasable body, wherein the clasp releasable body comprises a clasp, using the clasp to releasably secure the suspended load control apparatus to the load, and further comprising providing the clasp at least a one degree of freedom of clasp translation in the suspended load control apparatus with a clasp prismatic joint, and releasably precluding motion of the clasp in a one degree of freedom of clasp translation provided by the clasp prismatic joint, and further comprising controlling the load suspended below the carrier on a suspension cable with the SLCS.

Example 113. The method according to Example 112 or another claim or example herein, wherein the clasp prismatic joint comprises a bushing groove in a bushing and a flange, and further comprising fitting the flange within the bushing groove and releasably securing the clasp flange in the bushing groove, and thereby providing the one degree of freedom of clasp translation with the bushing groove and the flange.

Example 114. The method according to any one or more of Example 112 to Example 113 or another claim or example herein, further comprising releasably securing a clasp base plate bolt to the flange and thereby releasably securing the clasp to the suspended load control apparatus and thereby releasably precluding motion of the clasp in the one degree of freedom of clasp translation provided by the clasp prismatic joint.

Example 115. The method according to any one or more of Example 112 to Example 114 or another claim or example herein, further comprising releasably securing the clasp to the flange with the clasp base plate bolt and thereby generating a compressive force on and a friction between the clasp and the flange, and wherein the compressive force and the friction are to preclude motion of the clasp in the one degree of freedom of clasp translation and releasably prevent shear force on the clasp from translating the clasp in the one degree of freedom of clasp translation.

Example 116. The method according to any one or more of Example 112 to Example 113 or another claim or example herein, wherein the clasp releasable body comprises a clasp-position retaining pin, and further comprising releasably engaging the clasp-position retaining pin with a hole of or secured to the SLCS and thereby releasably preventing shear force on the clasp from translating the clasp in the one degree of freedom of clasp translation.

Example 117. The method according to any one or more of Example 112 to Example 116 or another claim or example herein, wherein the clasp-position retaining pin is spring loaded.

Example 118. The method according to any one or more of Example 112 to Example 116 or another claim or example herein, wherein the hole of or secured to the suspended load control apparatus is a hole in a bushing.

Example 119. The method according to any one or more of Example 112 to Example 118 or another claim or example herein, wherein the bushing is between the clasp and the suspended load control apparatus.

Example 120. The method according to any one or more of Example 112 to Example 118 or another claim or example herein, wherein the hole of or secured to the suspended load control apparatus is a first hole of or secured to the suspended load control apparatus, and further comprising a second hole of or secured to the suspended load control apparatus, wherein the first hole of or secured to the suspended load control apparatus and the second hole of or secured to the suspended load control apparatus are spaced to allow the clasp to be secured to a range of structures on the load.

Example 121. The method according to any one or more of Example 112 to Example 112 or another claim or example herein, wherein the SLCS further comprises a first thruster and a thruster positioning mechanism, wherein the thruster positioning mechanism comprises a thruster prismatic joint, wherein the thruster positioning mechanism and further comprising providing the first thruster at least a one degree of freedom of thruster translation in the suspended load control apparatus with the thruster prismatic joint.

Example 122. The method according to any one or more of Example 112 to Example 121 or another claim or example herein, further comprising a beam, further comprising releasably securing the first thruster to the bushing with the bushing and the beam between the clasp and the first thruster.

Example 123. The method according to any one or more of Example 112 to Example 122 or another claim or example herein, wherein the clasp comprises a clasp base plate and further comprising releasably securing clasp base plate to the bushing.

Example 124. The method according to any one or more of Example 112 to Example 123 or another claim or example herein, further comprising releasably securing the clasp base plate to the bushing with a bolt.

Example 125. The method according to any one or more of Example 112 to Example 115 or another claim or example herein, wherein the clasp comprises a clasp finger and a clasp finger engagement assembly, and further comprising releasably securing the clasp and the suspended load control apparatus to the load with the clasp finger engagement assembly.

Example 126. The method according to any one or more of Example 112 to Example 125 or another claim or example herein, wherein the clasp finger is a first clasp finger, further comprising a second clasp finger and wherein the clasp finger engagement assembly comprises a clasp cam, and further comprising releasably reducing releasably reducing a distance between the first clasp finger and the second clasp finger with the clasp cam, and further comprising a clasp release spring, and further comprising disengaging the clasp cam and thereby increasing the distance between the first clasp finger and the second clasp finger with the clasp release spring.

Example 127. The method according to any one or more of Example 112 to Example 126 or another claim or example herein, wherein the clasp further comprises a clasp pivot rod, further comprising rotating at least the first clasp finger about the clasp pivot rod between at least a first clasp posture and a second clasp posture.

Example 128. The method according to any one or more of Example 112 to Example 127 or another claim or example herein, wherein the first clasp posture is to secure the clasp to the load and the second clasp posture is to reduce a volume of space occupied by the clasp.

Example 129. The method according to any one or more of Example 112 to Example 128 or another claim or example herein, wherein the clasp further comprises a cam retaining trigger, and further comprising releasably retaining the clasp cam when the clasp cam is engaged relative to the first clasp finger and the second clasp finger with the cam retaining trigger.

Example 130. The method according to any one or more of Example 112 to Example 112 or another claim or example herein, wherein the load comprises a rescue litter.

Example 131. The method according to any one or more of Example 112 to Example 112 or another claim or example herein, wherein the suspended load control apparatus further comprises a computer processor and a memory; a sensor suite to obtain a sensor data regarding a position and orientation of the load control system and/or load; a data fusion module in the memory to determine an estimated state of the load control system and/or load based on the sensor data; a fan array comprising a first fan; and a decision and control module in the memory and further comprising controlling the fan array with the decision and control module to output at least one of a lateral force or torque on the load control system and/or load based on the estimated state of the load control system and/or load to control the load suspended from the carrier; wherein the load control system, including the sensor suite, are configured to be located proximate to the load at a bottom of a suspension cable spanning between the load and the carrier.

Example 132. The method according to any one or more of Example 112 to Example 131 or another claim or example herein, wherein the load control system and load are subject to an external force, wherein the external force is from at least one of movement of the load by the carrier, an environmental wind, or a wind generated by the carrier and wherein the external force causes or contributes to an undesired movement of the load control system and the load, and further comprising controlling the load suspended from the carrier to counteract the undesired movement of the load.

Example 133. The method according to any one or more of Example 112 to Example 132 or another claim or example herein, wherein to determine the estimated state of the load control system and/or load based on the sensor data comprises recursively predicting the estimated state based on a last previously estimated state, the sensor data, a system model, and an estimate of uncertainty of the estimated state.

Example 134. The method according to any one or more of Example 112 to Example 133 or another claim or example herein, wherein recursively predicting the estimated physical state based on a last previously estimated physical state, the sensor data, the system model, and the estimate of uncertainty of the estimated physical state comprises processing the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 135. The method according to any one or more of Example 112 to Example 134 or another claim or example herein, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 136. The method according to any one or more of Example 112 to Example 135 or another claim or example herein, wherein recursively predicting the estimated physical state based on a last previously estimated physical state, the sensor data, the system model, and the estimate of uncertainty of the estimated physical state comprises predicting at a location and motion in relative and absolute coordinate frames of at least one of the load, the load control system, or the carrier.

Example 137. The method according to any one or more of Example 112 to Example 136 or another claim or example herein, wherein to control the fan array to output at least one of the lateral force or torque on the load control system and/or load based on the estimated state of the load control system and/or load to control the load suspended from the carrier comprises to output frame states for the estimated state of the load control system and/or load, translate the frame states into multi-input multi-output (“MIMO”) control laws, determine an actuator matrix for the fan array, and output the MIMO control laws to the fan array according to the actuator matrix.

Example 138. The method according to any one or more of Example 112 to Example 112 or another claim or example herein, further comprising accommodating irregularities in at least one dimension of the load with the one degree of freedom of clasp translation.

Example 139. An apparatus to position at least a first thruster in a plurality of thrusters of a suspended load control apparatus, the apparatus comprising: means to position the thruster with a thruster prismatic joint, wherein the thruster prismatic joint comprises means to provide the first thruster at least a one degree of freedom of thruster translation in the suspended load control apparatus, and further comprising means to releasably preclude motion of the first thruster in the one degree of freedom of thruster translation provided by the thruster prismatic joint with a thruster releasable body, wherein the suspended load control apparatus comprises means to control a load suspended on a suspension cable below a carrier.

Example 140. The apparatus according to Example 139 or another claim or example herein, wherein the thruster prismatic joint comprises the first thruster and a beam.

Example 141. The apparatus according to any one or more of Example 139 to Example 140 or another claim or example herein, wherein the thruster prismatic joint comprises a first thruster structure, a beam structure, and further comprising means to interlock the first thruster structure and the beam structure to and thereby limit translation of the first thruster at least to the one degree of freedom of thruster translation, and further comprising means to releasably secure the thruster releasable body to the first thruster and across the beam structure to thereby releasably preclude motion of the first thruster in the one degree of freedom of thruster translation by releasably preventing shear force on the first thruster from translating the first thruster in the one degree of freedom of thruster translation.

Example 142. The apparatus according to any one or more of Example 139 to Example 141 or another claim or example herein, wherein the first thruster structure comprises a protrusion and the beam structure comprises a beam groove corresponding to the protrusion and further comprising means to interlock the protrusion and the beam groove and thereby limiting translation of the first thruster at least to the one degree of freedom of thruster translation in the suspended load control apparatus.

Example 143. The apparatus according to any one or more of Example 139 to Example 141 or another claim or example herein, wherein the thruster releasable body comprises a bushing.

Example 144. The apparatus according to any one or more of Example 139 to Example 143 or another claim or example herein, further comprising means to releasably secure the bushing to the first thruster, and thereby releasably precluding motion of the first thruster in the one degree of freedom of thruster translation by releasably preventing shear force on the first thruster from translating the first thruster in the one degree of freedom of thruster translation.

Example 145. The apparatus according to any one or more of Example 139 to Example 144 or another claim or example herein, further comprising means to releasably secure the bushing to the first thruster with a bolt and thereby generate a compressive force on and a friction between the bushing, the beam, and the first thruster, wherein the compressive force and the friction is to preclude motion of the first thruster in the one degree of freedom of thruster translation and releasably prevent shear force on the first thruster from translating the first thruster in the one degree of freedom of thruster translation.

Example 146. The apparatus according to any one or more of Example 139 to Example 140 or another claim or example herein, wherein beam is a first beam, further comprising a second beam, and wherein the thruster prismatic joint comprises the first thruster, the first beam, and the second beam.

Example 147. The apparatus according to any one or more of Example 139 to Example 146 or another claim or example herein, further comprising means to interpose the first thruster between the first beam and the second beam in the thruster prismatic joint.

Example 148. The apparatus according to any one or more of Example 139 to Example 146 or another claim or example herein, wherein the thruster releasable body is a first thruster releasable body and further comprising a second thruster releasable body and, with the thruster prismatic joint, means to releasably securing the first thruster to the first beam with the first thruster releasable body and means to releasably secure the first thruster to the second beam with the second thruster releasable body.

Example 149. The apparatus according to any one or more of Example 139 to Example 143 or another claim or example herein, further comprising a suspended load control apparatus or system (“SLCS”) securement mechanism, wherein the SLCS securement mechanism comprises a clasp, wherein the clasp comprises means to be releasably securable to the bushing and further comprising means to releasably secure the SCLS to the load with SLCS securement mechanism comprising the clasp.

Example 150. The apparatus according to any one or more of Example 139 to Example 149 or another claim or example herein, wherein the clasp comprises a clasp base plate and further comprising means to secure the clasp base plate to the bushing.

Example 151. The apparatus according to any one or more of Example 139 to Example 150 or another claim or example herein, further comprising means for the clasp prismatic joint to provide the clasp at least a one degree of freedom of clasp translation relative to the suspended load control apparatus.

Example 152. The apparatus according to any one or more of Example 139 to Example 151 or another claim or example herein, wherein the one degree of freedom of thruster translation and the one degree of freedom of clasp translation are perpendicular to one another.

Example 153. The apparatus according to any one or more of Example 139 to Example 151 or another claim or example herein, wherein the clasp prismatic joint comprises a bushing groove in the bushing and the clasp, and further comprising means to releasably secure the clasp to the bushing grove with a flange.

Example 154. The apparatus according to any one or more of Example 139 to Example 153 or another claim or example herein, further comprising a clasp releasable body, further comprising means to releasably secure the clasp releasable body to the flange and in the bushing grove and thereby releasably precluding motion of the clasp in the one degree of freedom of clasp translation provided by the clasp prismatic joint.

Example 155. The apparatus according to any one or more of Example 139 to Example 153 or another claim or example herein, wherein beam groove and the bushing groove are perpendicular to one another.

Example 156. The apparatus according to any one or more of Example 139 to Example 153 or another claim or example herein, wherein the clasp is a first clasp and further comprising a second clasp.

Example 157. The apparatus according to any one or more of Example 139 to Example 156 or another claim or example herein, wherein the bushing is first bushing and further comprising a second bushing, wherein the first clasp comprises a first clasp base plate and further comprising means to releasably secure the first clasp base plate to the first bushing with the first beam between the first clasp base plate, the first bushing, and the first thruster and wherein the second clasp comprises a second clasp base plate and further comprising means to releasably secure the second clasp base plate to the second bushing with the second bolt with the second beam between the second clasp base plate, the second bushing, and the first thruster.

Example 158. The apparatus according to any one or more of Example 139 to Example 140 or another claim or example herein, wherein the beam comprises at least one of a plate, an I-beam, or a tube, wherein the tube has a cross section comprising at least one of an ellipse and a rectangle.

Example 159. The apparatus according to Example 139 to Example 158 or another claim or example herein, wherein the thruster comprises a thruster housing and, within the thruster housing, at least one ducted fan.

Example 160. The apparatus according to any one or more of Example 139 to Example 159 or another claim or example herein, wherein the at least one ducted fan comprises a first ducted fan and a second ducted fan.

Example 161. The apparatus according to any one or more of Example 139 to Example 160 or another claim or example herein, wherein the load comprises a rescue litter.

Example 162. The apparatus according to any one or more of Example 139 to Example 161 or another claim or example herein, wherein the apparatus further comprises a computer processor and a memory; a sensor suite to obtain a sensor data regarding a position and orientation of the load control system and/or load; a data fusion module in the memory to determine an estimated state of the load control system and/or load based on the sensor data; a fan array comprising the first fan; and a decision and control module in the memory and further comprising means to control the fan array with the decision and control module to output at least one of a lateral force or torque on the load control system and/or load based on the estimated state of the load control system and/or load to control the load suspended from the carrier; wherein the load control system, including the sensor suite, are configured to be located proximate to the load at a bottom of a suspension cable spanning between the load and the carrier.

Example 163. The apparatus according to any one or more of Example 139 to Example 162 or another claim or example herein, wherein the apparatus and load are subject to an external force, wherein the external force is from at least one of movement of the load by the carrier, an environmental wind, or a wind generated by the carrier and wherein the external force causes or contributes to an undesired movement of the load control system and the load, and further comprising means to control the load suspended from the carrier to counteract the undesired movement of the load.

Example 164. The apparatus according to any one or more of Example 139 to Example 162 or another claim or example herein, wherein to determine the estimated state of the load control system and/or load based on the sensor data comprises means to recursively predict the estimated state based on a last previously estimated state, the sensor data, a system model, and an estimate of uncertainty of the estimated state.

Example 165. The apparatus according to any one or more of Example 139 to Example 164 or another claim or example herein, wherein means to recursively predict the estimated physical state based on a last previously estimated physical state, the sensor data, the system model, and the estimate of uncertainty of the estimated physical state comprises means to process the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 166. The apparatus according to any one or more of Example 139 to Example 165 or another claim or example herein, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 167. The apparatus according to any one or more of Example 139 to Example 166 or another claim or example herein, wherein means to recursively predict the estimated physical state based on a last previously estimated physical state, the sensor data, the system model, and the estimate of uncertainty of the estimated physical state comprises means to predict at a location and motion in relative and absolute coordinate frames of at least one of the load, the load control system, or the carrier.

Example 168. The apparatus according to any one or more of Example 139 to Example 167 or another claim or example herein, wherein means to control the fan array to output at least one of the lateral force or torque on the load control system and/or load based on the estimated state of the load control system and/or load to control the load suspended from the carrier comprises means to output frame states for the estimated state of the load control system and/or load, translate the frame states into multi-input multi-output (“MIMO”) control laws, determine an actuator matrix for the fan array, and output the MIMO control laws to the fan array according to the actuator matrix.

Example 169. An apparatus to releasably secure a suspended load control apparatus (“SLCS”) to a load, the apparatus comprising means to: with a clasp prismatic joint and a clasp releasable body, wherein the clasp releasable body comprises a clasp, means for the clasp to releasably secure the suspended load control apparatus to the load, and further comprising means for the clasp to provide at least a one degree of freedom of clasp translation in the suspended load control apparatus with a clasp prismatic joint and thereby releasably precluding motion of the clasp in a one degree of freedom of clasp translation provided by the clasp prismatic joint, and further comprising means to control the load suspended below the carrier on a suspension cable with the SLCS.

Example 170. The apparatus according to Example 169 or another claim or example herein, wherein the clasp prismatic joint comprises a bushing groove in a bushing and a flange, and further comprising means to fit the flange within the bushing groove and releasably secure the clasp flange in the bushing groove and thereby provide the one degree of freedom of clasp translation with the bushing groove and the flange.

Example 171. The apparatus according to any one or more of Example 169 to Example 170 or another claim or example herein, further comprising means to releasably secure a clasp base plate bolt to the flange and thereby releasably secure the clasp to the suspended load control apparatus and thereby releasably preclude motion of the clasp in the one degree of freedom of clasp translation provided by the clasp prismatic joint.

Example 172. The apparatus according to any one or more of Example 169 to Example 171 or another claim or example herein, further comprising means to releasably secure the clasp to the flange with the clasp base plate bolt and thereby generate a compressive force on and a friction between the clasp and the flange, wherein the compressive force and the friction are to preclude motion of the clasp in the one degree of freedom of clasp translation and releasably prevent shear force on the clasp from translating the clasp in the one degree of freedom of clasp translation.

Example 173. The apparatus according to any one or more of Example 169 to Example 170 or another claim or example herein, wherein the clasp releasable body comprises a clasp-position retaining pin, and further comprising means to releasably engage the clasp-position retaining pin with a hole of or secured to the SLCS and thereby releasably prevent shear force on the clasp from translating the clasp in the one degree of freedom of clasp translation.

Example 174. The apparatus according to any one or more of Example 169 to Example 173 or another claim or example herein, wherein the clasp-position retaining pin is spring loaded.

Example 175. The apparatus according to any one or more of Example 169 to Example 173 or another claim or example herein, wherein the hole of or secured to the suspended load control apparatus is a hole in a bushing.

Example 176. The apparatus according to any one or more of Example 169 to Example 175 or another claim or example herein, wherein the bushing is between the clasp and the suspended load control apparatus.

Example 177. The apparatus according to any one or more of Example 169 to Example 175 or another claim or example herein, wherein the hole of or secured to the suspended load control apparatus is a first hole of or secured to the suspended load control apparatus, and further comprising a second hole of or secured to the suspended load control apparatus, wherein the first hole of or secured to the suspended load control apparatus and the second hole of or secured to the suspended load control apparatus are spaced to allow the clasp to be secured to a range of structures on the load.

Example 178. The apparatus according to any one or more of Example 169 to Example 177 or another claim or example herein, wherein the SLCS further comprises a first thruster and a thruster positioning mechanism, wherein the thruster positioning mechanism comprises means for a thruster prismatic joint, wherein the thruster prismatic joint further comprises means to provide the first thruster at least a one degree of freedom of thruster translation in the suspended load control apparatus with the thruster prismatic joint.

Example 179. The apparatus according to any one or more of Example 169 to Example 178 or another claim or example herein, further comprising a beam, further comprising means to releasably secure the first thruster to the bushing with the bushing and the beam between the clasp and the first thruster.

Example 180. The apparatus according to any one or more of Example 169 to Example 179 or another claim or example herein, wherein the clasp comprises a clasp base plate and further comprising means to releasably secure clasp base plate to the bushing.

Example 181. The apparatus according to any one or more of Example 169 to Example 180 or another claim or example herein, further comprising means to releasably secure the clasp base plate to the bushing with a bolt.

Example 182. The apparatus according to any one or more of Example 169 to Example 172 or another claim or example herein, wherein the clasp comprises a clasp finger and a clasp finger engagement assembly, and further comprising means to releasably secure the clasp and the suspended load control apparatus to the load with the clasp finger engagement assembly.

Example 183. The apparatus according to any one or more of Example 169 to Example 182 or another claim or example herein, wherein the clasp finger is a first clasp finger, further comprising a second clasp finger and wherein the clasp finger engagement assembly comprises a clasp cam, and further comprising means to releasably reduce a distance between the first clasp finger and the second clasp finger with the clasp cam, and further comprising a clasp release spring, and further comprising means to disengage the clasp cam and thereby increase the distance between the first clasp finger and the second clasp finger with the clasp release spring.

Example 184. The apparatus according to any one or more of Example 169 to Example 183 or another claim or example herein, wherein the clasp further comprises a clasp pivot rod, further comprising means to rotate at least the first clasp finger about the clasp pivot rod between at least a first clasp posture and a second clasp posture.

Example 185. The apparatus according to any one or more of Example 169 to Example 184 or another claim or example herein, wherein the first clasp posture is to secure the clasp to the load and the second clasp posture is to reduce a volume of space occupied by the clasp.

Example 186. The apparatus according to any one or more of Example 169 to Example 185 or another claim or example herein, wherein the clasp further comprises a cam retaining trigger, and further comprising means to releasably engage the clasp cam retaining trigger.

Example 187. The apparatus according to any one or more of Example 169 to Example 186 or another claim or example herein, wherein the load comprises a rescue litter.

Example 188. The apparatus according to any one or more of Example 169 to Example 187 or another claim or example herein, wherein the suspended load control apparatus further comprises a computer processor and a memory; a sensor suite to obtain a sensor data regarding a position and orientation of the load control system and/or load; a data fusion module in the memory to determine an estimated state of the load control system and/or load based on the sensor data; a fan array comprising a first fan; and a decision and control module in the memory and further comprising means to control the fan array with the decision and control module to output at least one of a lateral force or torque on the load control system and/or load based on the estimated state of the load control system and/or load to control the load suspended from the carrier; wherein the load control system, including the sensor suite, are configured to be located proximate to the load at a bottom of a suspension cable spanning between the load and the carrier.

Example 189. The apparatus according to any one or more of Example 169 to Example 188 or another claim or example herein, wherein the load control system and load are subject to an external force, wherein the external force is from at least one of movement of the load by the carrier, an environmental wind, or a wind generated by the carrier and wherein the external force causes or contributes to an undesired movement of the load control system and the load, and further comprising means to control the load suspended from the carrier to counteract the undesired movement of the load.

Example 190. The apparatus according to any one or more of Example 169 to Example 189 or another claim or example herein, wherein means to determine the estimated state of the load control system and/or load based on the sensor data comprises means to recursively predict the estimated state based on a last previously estimated state, the sensor data, a system model, and an estimate of uncertainty of the estimated state.

Example 191. The apparatus according to any one or more of Example 169 to Example 189 or another claim or example herein, wherein means to recursively predict the estimated physical state based on a last previously estimated physical state, the sensor data, the system model, and the estimate of uncertainty of the estimated physical state comprises means to process the last previously estimated physical state, the sensor data, and the estimate of uncertainty of the estimated physical state in the system model with at least one of a non-linear data fusion method, a real-time kinetic algorithm, a Kalman filter, an unscented Kalman filter, a complimentary filter, or a transfer function model.

Example 192. The apparatus according to any one or more of Example 169 to Example 191 or another claim or example herein, wherein the system model comprises at least one of mass of SLCS and load, cable length, inertia of SLCS and load, movement and rotation SLCS, movement and rotation of the carrier, and disturbance estimations of wind force, sea state, and relative SLCS and helicopter motion.

Example 193. The apparatus according to any one or more of Example 169 to Example 192 or another claim or example herein, wherein means to recursively predict the estimated physical state based on a last previously estimated physical state, the sensor data, the system model, and the estimate of uncertainty of the estimated physical state comprises means to predict at a location and motion in relative and absolute coordinate frames of at least one of the load, the load control system, or the carrier.

Example 194. The apparatus according to any one or more of Example 169 to Example 193 or another claim or example herein, wherein means to control the fan array to output at least one of the lateral force or torque on the load control system and/or load based on the estimated state of the load control system and/or load to control the load suspended from the carrier comprises means to output frame states for the estimated state of the load control system and/or load, translate the frame states into multi-input multi-output (“MIMO”) control laws, determine an actuator matrix for the fan array, and output the MIMO control laws to the fan array according to the actuator matrix.

Example 195. The apparatus according to any one or more of Example 169 to Example 194 or another claim or example herein, further comprising accommodating irregularities in at least one dimension of the load with the one degree of freedom of clasp translation.

1. A suspended load control apparatus or system (“SLCS”) securement mechanism to releasably secure a suspended load control apparatus to a load, the SLCS securement mechanism comprising: a clasp prismatic joint, a clasp releasable body, wherein the clasp releasable body comprises a clasp, wherein the clasp is to releasably secure the suspended load control apparatus to the load, wherein the clasp prismatic joint is to provide the clasp at least a one degree of freedom of clasp translation in the suspended load control apparatus, wherein the clasp releasable body is to releasably preclude motion of the clasp in the one degree of freedom of clasp translation provided by the clasp prismatic joint, and wherein the suspended load control apparatus is to control the load suspended below the carrier on a suspension cable.

2. The SLCS securement mechanism according to claim 1, wherein the clasp prismatic joint comprises a bushing groove in a bushing and a flange, wherein the flange fits within the bushing groove, the flange is to releasably secure the clasp in the flange, and the bushing groove and the flange together provide the one degree of freedom of clasp translation.

3. The SLCS securement mechanism according to claim 2, wherein the clasp releasable body comprises a clasp base plate bolt releasably secured to the flange, and the clasp base plate bolt and the flange are to releasably secure the clasp to the suspended load control apparatus and releasably preclude motion of the clasp in the one degree of freedom of clasp translation provided by the clasp prismatic joint.

4. The SLCS securement mechanism according to claim 2, wherein the clasp releasable body comprises a clasp-position retaining pin, wherein the clasp-position retaining pin is to releasably engage with a hole of or secured to the SLCS and releasably prevent shear force on the clasp from translating the clasp in the one degree of freedom of clasp translation.

5. The SLCS securement mechanism according to claim 4, wherein the hole of or secured to the suspended load control apparatus is a hole in a bushing.

6. The SLCS securement mechanism according to claim 1, wherein the SLCS securement mechanism further comprises a first thruster and a thruster positioning mechanism, wherein the thruster positioning mechanism comprises a thruster prismatic joint, wherein the thruster positioning mechanism and thruster prismatic joint are to provide the first thruster at least a one degree of freedom of thruster translation in the suspended load control apparatus.

7. The SLCS securement mechanism according to claim 6, wherein the one degree of freedom of thruster translation and the one degree of freedom of clasp translation are perpendicular to one another.

8. The SLCS securement mechanism according to claim 1, further comprising a first clasp finger, a second clasp finger, a clasp cam, and a clasp release spring, wherein the clasp cam is to releasably reduce a distance between the first clasp finger and the second clasp finger when the clasp cam is engaged, and wherein the clasp release spring is to increase the distance between the first clasp finger and the second clasp finger when the clasp cam is disengaged.

9. The SLCS securement mechanism according to claim 8, wherein the clasp further comprises a clasp pivot rod, wherein the clasp pivot rod is to allow at least the first clasp finger to rotate about the clasp pivot rod between at least a first clasp posture and a second clasp posture.

10. A method to releasably secure a suspended load control apparatus (“SLCS”) to a load, the method comprising: with a clasp prismatic joint and a clasp releasable body, wherein the clasp releasable body comprises a clasp, using the clasp to releasably secure the suspended load control apparatus to the load, and further comprising providing the clasp at least a one degree of freedom of clasp translation in the suspended load control apparatus with a clasp prismatic joint, and releasably precluding motion of the clasp in a one degree of freedom of clasp translation provided by the clasp prismatic joint, and further comprising controlling the load suspended below the carrier on a suspension cable with the SLCS.

11. The method according to claim 10, wherein the clasp prismatic joint comprises a bushing groove in a bushing and a flange, and further comprising fitting the flange within the bushing groove and releasably securing the clasp flange in the bushing groove and thereby providing the one degree of freedom of clasp translation with the bushing groove and the flange.

12. The method according to claim 11, further comprising releasably securing a clasp base plate bolt to the flange and thereby releasably securing the clasp to the suspended load control apparatus and thereby releasably precluding motion of the clasp in the one degree of freedom of clasp translation provided by the clasp prismatic joint.

13. The method according to claim 11, wherein the clasp releasable body comprises a clasp-position retaining pin, and further comprising releasably engaging the clasp-position retaining pin with a hole of or secured to the SLCS and thereby releasably preventing shear force on the clasp from translating the clasp in the one degree of freedom of clasp translation.

14. The method according to claim 13, wherein the hole of or secured to the suspended load control apparatus is a hole in a bushing.

15. The method according to claim 10, wherein the SLCS further comprises a first thruster and a thruster positioning mechanism, wherein the thruster positioning mechanism comprises a thruster prismatic joint, wherein the thruster positioning mechanism and further comprising providing the first thruster at least a one degree of freedom of thruster translation in the suspended load control apparatus with the thruster prismatic joint.

16. The method according to claim 15, wherein the one degree of freedom of thruster translation and the one degree of freedom of clasp translation are perpendicular to one another.

17. An apparatus to position at least a first thruster in a plurality of thrusters of a suspended load control apparatus, the apparatus comprising: means to position the thruster with a thruster prismatic joint, wherein the thruster prismatic joint comprises means to provide the first thruster at least a one degree of freedom of thruster translation in the suspended load control apparatus, and further comprising means to releasably preclude motion of the first thruster in the one degree of freedom of thruster translation provided by the thruster prismatic joint with a thruster releasable body, wherein the suspended load control apparatus comprises means to control a load suspended on a suspension cable below a carrier.

18. The apparatus according to claim 17, wherein the thruster prismatic joint comprises the first thruster and a beam.

19. The apparatus according to claim 18, wherein the thruster prismatic joint comprises a first thruster structure, a beam structure, and further comprising means to interlock the first thruster structure and the beam structure to and thereby limit translation of the first thruster at least to the one degree of freedom of thruster translation, and further comprising means to releasably secure the thruster releasable body to the first thruster and across the beam structure to thereby releasably preclude motion of the first thruster in the one degree of freedom of thruster translation by releasably preventing shear force on the first thruster from translating the first thruster in the one degree of freedom of thruster translation.

20. The apparatus according to claim 19, wherein the first thruster structure comprises a protrusion and the beam structure comprises a beam groove corresponding to the protrusion and further comprising means to interlock the protrusion and the beam groove and thereby limiting translation of the first thruster at least to the one degree of freedom of thruster translation in the suspended load control apparatus.
